(19) United States
(12) Patent Application Publication
(10) Pub. No.: US 2024/0295723 A1
(43) Pub. Date: Sep. 5, 2024

(54) ZOOM LENS AND IMAGING DEVICE

(71) Applicant: Tamron Co., Ltd., Saitama (JP)

(72) Inventor: Takahiko SAKAI, Saitama (JP)

(73) Assignee: Tamron Co., Ltd., Saitama (JP)

(21) Appl. No.: 18/526,915

(22) Filed: Dec. 1, 2023

(30) Foreign Application Priority Data
Feb. 24, 2023 (JP) 2023-027254

(51) Int. Cl. G02B 15/14; G02B 9/64; G02B 13/02

(52) U.S. Cl. CPC G02B 15/145105; G02B 9/64; G02B 13/02

(57) ABSTRACT

A zoom lens includes, in order from an object side, a positive first lens group, a negative second lens group, a positive third lens group, a negative fourth lens group, and a negative fifth lens group, and magnifies by changing an interval on an optical axis between adjacent lens groups. The third lens group includes an object side portion group arranged on an object side with a widest air interval in the third lens group and an image side portion group arranged on an image side of the object side portion group, and the second lens group moves along the optical axis at a time of magnification change. The object side portion group and the image side portion group each include a positive lens, a positive lens, and a negative lens arranged in order from the object side. Further, an imaging device including the zoom lens is provided.

### CROSS-REFERENCE TO RELATED APPLICATIONS

This application is based on and claims the benefit of priority from Japanese Patent Application No. 2023-027254, filed on Feb. 24, 2023, the entire contents of which are incorporated herein by reference.

### BACKGROUND OF THE INVENTION

### Technical Field

The present invention relates to a zoom lens and an imaging device.

### Related Art

Conventionally, imaging devices using solid-state image sensors such as digital still cameras and digital video cameras have been widely used. Examples of such an imaging device include various devices such as a digital still camera, a digital video camera, a broadcast camera/film camera, a surveillance camera, and an in-vehicle camera. As an imaging optical system used in an imaging device, a zoom lens capable of adjusting a focal length according to a subject is widely used. Along with high integration of light receiving elements constituting a solid-state image sensor, further improvement in performance and downsizing of a zoom lens are required. In addition, a zoom lens having a high magnification is required, and it is required to realize a longer focal length at a telephoto end, and it is required to realize a wider angle of view at a wide-angle end.

For example, JP 2020-101838 A proposes a zoom lens that adopts a zoom configuration of a group of five positive, negative, positive, negative, and negative lenses and realizes a magnification ratio of about 4.7 times. In addition, JP 2020-140218 A proposes a zoom lens that adopts a zoom configuration of a group of five positive, negative, positive, negative, and negative lenses and realizes a magnification ratio of about 4.0 times as in JP 2020-101838 A. Since these zoom lenses each have a relatively simple lens configuration, the zoom lens can be made compact.

However, the zoom lens has a magnification ratio of 5 times or less, and it is required to realize a zoom lens having a higher magnification ratio while maintaining a similar lens configuration and miniaturizing the entire zoom lens.

That is, an object of the present invention is to provide a zoom lens and an imaging device which have high optical performance, are compact, and have a high magnification ratio.

### SUMMARY OF THE INVENTION

In order to solve the above problem, a zoom lens according to the present invention is a zoom lens including: in order from an object side, a first lens group having positive refractive power; a second lens group having negative refractive power; a third lens group having positive refractive power; a fourth lens group having negative refractive power; and a fifth lens group having negative refractive power. Magnification varies by changing an interval on an optical axis between adjacent lens groups. The third lens group includes an object side portion group arranged on an object side with a widest air interval in the third lens group, and an image side portion group arranged on an image side with the air interval. The second lens group moves along an optical axis at a time of magnification change. The object side portion group and the image side portion group each include a positive lens, a positive lens, and a negative lens arranged in order from an object side.

In order to solve the above problems, an imaging device according to the present invention includes the zoom lens and an image sensor that converts an optical image formed by the zoom lens into an electrical signal.

According to the present invention, it is possible to provide a zoom lens and an imaging device which have high optical performance, are compact, and have a high magnification ratio.

### BRIEF DESCRIPTION OF THE DRAWINGS

FIG. 1 is a lens cross-sectional view of a zoom lens according to Example 1 (note that an upper part is a lens cross-sectional view at a wide-angle end, and a lower part is a lens cross-sectional view at a telephoto end. The same applies hereinafter);

FIG. 2 is various aberration diagrams at a wide-angle end of the zoom lens according to Example 1;

FIG. 3 is various aberration diagrams at a telephoto end of the zoom lens according to Example 1;

FIG. 4 is a lens cross-sectional view of a zoom lens according to Example 2;

FIG. 5 is various aberration diagrams at a wide-angle end of the zoom lens according to Example 2;

FIG. 6 is various aberration diagrams at the telephoto end of the zoom lens according to Example 2;

FIG. 7 is a lens cross-sectional view of a zoom lens according to Example 3;

FIG. 8 is various aberration diagrams at a wide-angle end of the zoom lens according to Example 3;

FIG. 9 is various aberration diagrams at the telephoto end of the zoom lens according to Example 3;

FIG. 10 is a lens cross-sectional view of a zoom lens of Example 4;

FIG. 11 is various aberration diagrams at a wide-angle end of the zoom lens of Example 4;

FIG. 12 is various aberration diagrams at the telephoto end of the zoom lens of Example 4;

FIG. 13 is a lens cross-sectional view of a zoom lens of Example 5;

FIG. 14 is various aberration diagrams at the wide-angle end of the zoom lens of Example 5;

FIG. 15 is various aberration diagrams at the telephoto end of the zoom lens of Example 5;

FIG. 16 is a lens cross-sectional view of a zoom lens of Example 6;

FIG. 17 is various aberration diagrams at a wide-angle end of the zoom lens of Example 6;

FIG. 18 is various aberration diagrams at the telephoto end of the zoom lens of Example 6;

FIG. 19 is a lens cross-sectional view of a zoom lens of Example 7;

FIG. 20 is various aberration diagrams at a wide-angle end of the zoom lens of Example 7;

FIG. 21 is various aberration diagrams at the telephoto end of the zoom lens of Example 7; and

FIG. 22 is a diagram schematically illustrating an example of a configuration of an imaging device according to an embodiment of the present invention.

### DESCRIPTION OF THE EMBODIMENTS

Hereinafter, embodiments of a zoom lens and an imaging device according to the present invention will be described. However, the zoom lens and the imaging device described below are one aspect of the zoom lens and the imaging device according to the present invention, and the zoom lens and the imaging device according to the present invention are not limited to the following aspects.

### 1. Zoom Lens

### 1-1. Optical Configuration

The zoom lens includes, in order from an object side, a first lens group having positive refractive power, a second lens group having negative refractive power, a third lens group having positive refractive power, a fourth lens group having negative refractive power, and a fifth lens group having negative refractive power, and magnifies by changing an interval on an optical axis between adjacent lens groups. However, in the present specification, the lens group includes at least one lens, and an interval between adjacent lens groups changes at the time of magnification change.

The zoom lens includes five lens groups, and although the lens group configuration is relatively simple, various aberrations can be satisfactorily corrected in the entire zoom region while realizing a high magnification ratio, and high optical performance can be obtained. Hereinafter, a preferable lens configuration of each lens group will be described.

However, the zoom lens according to the present invention is substantially configured by the first lens group to the fifth lens group. In addition, with respect to the lens constituting each lens group, the lens having positive refractive power and the lens having negative refractive power described above mean a lens having substantial refractive power. In addition, the number of lenses described above means the number of lenses having substantial refractive power. That is, the zoom lens may include a lens having no substantial refractive power, an optical element other than a lens such as an optical filter or a parallel flat plate, and the like, in addition to the lens group or the lens substantially constituting the lens group.

### (1) First Lens Group

A specific lens configuration of the first lens group is not particularly limited as long as the first lens group has positive refractive power. In order to satisfactorily correct various aberrations and realize a zoom lens with high optical performance, it is preferable to include at least one negative lens. Further, in order to make the zoom lens compact, the number of lenses constituting the first lens group is preferably three or less.

### (2) Second Lens Group

A specific lens configuration of the second lens group is not particularly limited as long as the second lens group has negative refractive power. In order to satisfactorily correct various aberrations and realize a zoom lens with high optical performance, it is preferable to include at least one positive lens. In order to realize a high magnification ratio with a small lens group configuration, the second lens group preferably includes two or more negative lenses and one or more positive lenses.

In addition, the second lens group preferably includes a vibration-compensation group that moves in a direction perpendicular to the optical axis to correct image blurring. When the high magnification ratio is realized and the focal length at the telephoto end becomes long, the influence of image blurring caused by camera shake or the like at the time of photographing increases. The second lens group is constituted by a lens having a smaller diameter than a so-called front lens and a rear lens. Therefore, by disposing the vibration-compensation group in the second lens group, it is easy to secure a space for disposing a drive mechanism or the like for moving the vibration-compensation group in the direction perpendicular to the optical axis in a lens barrel, and it is possible to favorably correct the image blurring even when a high magnification ratio is achieved while the entire zoom lens is made compact.

When the vibration-compensation group is arranged in the second lens group, the vibration-compensation group preferably includes at least one negative lens and at least one positive lens. However, in order to downsize the zoom lens, the vibration-compensation group may include a positive lens or a negative lens. However, by including at least one negative lens and at least one positive lens, deterioration of optical performance at the time of image blurring correction can be prevented, and high optical performance can be realized also at the time of image blurring correction. Further, in the vibration-compensation group, it is more preferable that the negative lens and the positive lens are arranged in this order from the object side.

Preferably, the vibration-compensation group includes at least one cemented lens. At this time, the cemented lens preferably includes at least one negative lens and at least one positive lens. By including one or more positive lenses and one or more negative lenses, deterioration of optical performance can be prevented as described above, which is preferable. In addition, by including the cemented lens, the work of assembling the vibration-compensation group to the lens frame or the like becomes easy, and the occurrence of an assembly error or the like can be suppressed.

Furthermore, the vibration-compensation group is preferably composed of one negative lens and one positive lens. In this case, the vibration-compensation group can be made compact while suppressing deterioration of optical performance at the time of image blurring correction. By making the vibration-compensation group compact and lightweight, a drive mechanism such as an actuator for moving the vibration-compensation group in a direction perpendicular to the optical axis can also be made compact. Therefore, the entire zoom lens including the lens barrel portion can be made compact. At this time, it is more preferable that the vibration-compensation group is configured by a cemented lens in which one negative lens and one positive lens are cemented. In this case as well, it is preferable that the negative lens and the positive lens are arranged in this order in the vibration-compensation group.

### (3) Third Lens Group

The third lens group has positive refractive power and includes at least two lenses. Here, an object side having the widest air interval in the third lens group is defined as an object side portion group, an image side having the air interval is defined as an image side portion group, and each of the object side portion group and the image side portion group includes one or more lenses. However, it is assumed that the object side portion group and the image side portion group integrally move on the optical axis at the time of magnification change, and the air interval between the object side portion group and the image side portion group does not change at the time of magnification change.

The object side portion group and the image side portion group preferably include a positive lens, a positive lens, and a negative lens which are arranged in order from the object side. By arranging three lenses in the order from the object side in each of the object side portion group and the image side portion group, and separating the object side portion group and the image side portion group by the widest air interval in the third lens group, for example, even when the third lens group is constituted by six lenses, various aberrations can be satisfactorily corrected in the entire magnification range, and high optical performance can be obtained. In this way, since various aberrations can be satisfactorily corrected in the entire magnification range, a high magnification ratio can be realized, and a wider angle of view can be realized at the wide-angle end.

### (4) Fourth Lens Group

A specific lens configuration of the fourth lens group is not particularly limited as long as the fourth lens group is a lens group having negative refractive power. In order to satisfactorily correct various aberrations and realize a zoom lens with high optical performance, it is preferable to include at least one positive lens.

Preferably, the fourth lens group includes at least one cemented lens. Since the cemented lens includes at least one negative lens and at least one positive lens, it is possible to suppress the occurrence of an assembly error and the like while satisfactorily correcting various aberrations. At this time, in the fourth lens group, it is more preferable that the negative lens and the positive lens are arranged in this order from the object side.

Further, the fourth lens group is preferably composed of one positive lens and one negative lens. By configuring the fourth lens group with two lenses, the number of lenses constituting the zoom lens can be reduced, and the overall configuration can be easily made compact.

### (5) Fifth Lens Group

A specific lens configuration of the fifth lens group is not particularly limited as long as the fifth lens group is a lens group having negative refractive power. By arranging the lens group having the negative refractive power on the most image side, it is easy to achieve a wide angle. In addition, since the back focus can be shortened while widening the angle, it is also preferable to shorten the overall optical length at the wide-angle end. In order to satisfactorily correct various aberrations and realize a zoom lens with high optical performance, it is preferable to include at least one positive lens. In order to shorten the back focus while achieving wider angle, it is preferable that the image side surface of the lens arranged closest to the image side in the fifth lens group has a convex shape toward the image surface side. The lens disposed closest to the image side is preferably a negative lens, and more preferably a negative meniscus lens having a convex shape on the image surface side.

### 1-2. Operation During Zooming

In the zoom lens, each lens group may be a movable lens group movable with respect to the image plane or may be a fixed lens group fixed with respect to the image plane as long as the interval on the optical axis between the adjacent lens groups changes at the time of magnification change. If all the lens groups are movable lens groups, the positions of the lens groups can be changed at the time of magnification change from the wide-angle end to the telephoto end, which is preferable in correcting various aberrations. In particular, in order to realize a high magnification ratio, the second lens group is preferably a movable lens group. The other lens groups may be the movable lens group or the fixed lens group as described above, but it is preferable to set at least three lens groups as the movable lens groups in order to realize the high magnification ratio, and it is also preferable to set all the lens groups as the movable lens groups.

### 1-3. Operation During Focusing

In the zoom lens, the focus group is not particularly limited, and it is preferable to focus on a near-distance object from infinity by moving any one or more lens groups or a part thereof in the optical axis direction. Since the first lens group is constituted by a lens having a relatively large outer diameter, it is preferable to use a lens group subsequent to the second lens group as the focus group.

In particular, the fourth lens group can include a lens having a smaller diameter than other lens groups. Therefore, it is easy to secure an arrangement space of the focus drive mechanism for moving the fourth lens group in the optical axis direction at the time of focusing around the fourth lens group in the lens barrel. Furthermore, by reducing the size and weight of the focus group, it is possible to reduce the size and weight of the focus drive mechanism. In addition, even when the vibration-compensation group is arranged in the second lens group, it is preferable because interference between the vibration-compensation drive mechanism for moving the vibration-compensation group in the direction perpendicular to the optical axis in the lens barrel and the focus drive mechanism can be prevented. However, the direction of movement of the fourth lens group at the time of focusing from infinity to a near-distance object is not particularly limited. Thus, it is easier to reduce the size and weight of the entire zoom lens.

In addition, if the fourth lens group is a focus group, the focus group can be reduced in size and weight, and thus the focus group can be moved at a high speed, so that a moving subject or the like can be quickly focused. Therefore, a zoom lens suitable for capturing a moving image can be obtained.

### 1-4. Aperture Diaphragm

In the zoom lens, the position of the diaphragm is not particularly limited. However, the diaphragm refers to an aperture diaphragm for determining the diameter of the on-axis light flux. For example, by disposing the aperture diaphragm before and after the third lens group or in the third lens group, the lens diameter can be reduced, and it is easy to reduce the diameter of the zoom lens. Further, in the third lens group, it is more preferable to arrange the aperture diaphragm before and after the object side portion group or in the object side portion group in order to obtain the effect.

### 1-5. Conditional Expression

The zoom lens preferably adopts the above-described configuration and satisfies at least one of the following conditional expressions.

### 1-5-1. Expression (1)

In the zoom lens, it is preferable that at least one of the positive lenses included in the image side portion group satisfies the following Expression (1).

$$0.565 < ( ng - nF ) / ( nF - nC ) < 0.6 \qquad ( 1 )$$

Where,

ng is a refractive index with respect to g-line of positive lens included in image side portion group;

nF is a refractive index with respect to F-line of positive lens included in image side portion group; and

nC is a refractive index with respect to C-line of positive lens included in image side portion group.

Expression (1) is an expression representing a partial dispersion ratio from the g-line to the F-line of (the lens material constituting) the positive lens included in the image side portion group. When at least one positive lens satisfying Expression (1) is included in the image side portion group, axial chromatic aberration generated in the object side portion group in the third lens group can be satisfactorily corrected in the image side portion group, and high optical performance can be easily realized while the zoom lens is configured with a small number of lenses. It is also preferable that the image side portion group include two or more positive lenses satisfying Expression (1).

However, the g-line represents a light beam having a wavelength of 435.84 nm, the F-line represents a light beam having a wavelength of 486.13 nm, the C-line represents a light beam having a wavelength of 656.27 nm, and the d-line described later represents a light beam having a wavelength of 587.56 nm.

On the other hand, in a case where the positive lens satisfying Expression (1) is not included in the image side portion group, the axial chromatic aberration is overcorrected, and it becomes difficult to realize high optical performance with a small number of lenses, and it becomes difficult to miniaturize the zoom lens while maintaining high optical performance.

In order to obtain the above effect, the upper limit value of Expression (1) is more preferably 0.595, still more preferably 0.590, and still more preferably 0.585. The lower limit value of Expression (1) is more preferably 0.570 and still more preferably 0.575. When these preferable upper limit values are adopted, an inequality sign (<) in Expression (1) may be replaced with an inequality sign with an equality sign (s). As the lower limit value, an inequality sign or an inequality sign with an equal sign can be adopted. The same applies to the other expressions, and the same applies to the lower limit value in the other expressions.

### 1-5-2. Expression (2)

$$33. < vd 3 B < 41. \qquad ( 2 )$$

Where,

νd3B is Abbe number with respect to d-line of positive lens included in image side portion group.

Expression (2) defines the Abbe number with respect to the d-line of the positive lens included in the image side portion group. When the image side portion group includes a positive lens satisfying the above Expression (2), the axial chromatic aberration generated in the object side portion group in the third lens group can be corrected well in the image side portion group, and high optical performance can be easily realized while the zoom lens is configured with a small number of lenses. It is also preferable that the image side portion group include two or more positive lenses satisfying Expression (2).

On the other hand, when the Abbe numbers with respect to the d-line of the positive lenses included in the image side portion group are all equal to or larger than the upper limit value of Expression (2), the axial chromatic aberration is overcorrected. On the other hand, when the Abbe numbers with respect to the d-line of the positive lenses included in the image side portion group are all equal to or less than the lower limit value of Expression (2), the axial chromatic aberration is insufficiently corrected. Therefore, in a case where the image side portion group does not include any positive lens satisfying Expression (2), it is difficult to realize high optical performance with a small number of lenses, and it is difficult to miniaturize the zoom lens while maintaining high optical performance.

In order to obtain the above effect, the upper limit value of Expression (2) is more preferably 39.70, still more preferably 38.50, still more preferably 36.00, and still more preferably 35.90. The lower limit value of Expression (2) is more preferably 33.80 and still more preferably 34.70.

Here, it is preferable that at least one of the positive lenses included in the image side portion group satisfies both the above Expressions (1) and (2). Consequently, the axial chromatic aberration generated in the object side portion group can better be corrected in the image side portion group, and the higher optical performance can be realized in the entire magnification range.

### 1-5-3. Expression (3)

$$0.041 < 3 DM / OALw < 0.095 \qquad ( 3 )$$

Where,

3DM is a widest air interval in third lens group; and

OALw is overall optical length at the wide-angle end of the zoom lens.

Expression (3) defines a ratio between the widest air interval in the third lens group and the overall optical length at the wide-angle end of the zoom lens. By satisfying Expression (3), the overall optical length of the third lens group falls within an appropriate range, and various aberrations can be satisfactorily corrected. That is, by satisfying Expression (3), it becomes easier to realize a zoom lens that is compact and has high optical performance.

On the other hand, when the numerical value of Expression (3) is equal to or larger than the upper limit value, the overall optical length of the third lens group becomes larger than the appropriate range with respect to the overall optical length at the wide-angle end of the zoom lens, which leads to an increase in size of the zoom lens, which is not preferable. On the other hand, when the numerical value of the conditional expression (3) is less than or equal to the lower limit value, the maximum air interval in the third lens group becomes shorter than the overall optical length at the wide-angle end of the zoom lens. That is, a sufficient air interval cannot be provided between the object side portion group and the image side portion group, and correction of various aberrations in the third lens group is insufficient, which is not preferable.

In order to obtain the above effect, the upper limit value of Expression (3) is more preferably 0.090 and still more preferably 0.089. The lower limit value of Expression (3) is more preferably 0.043 and still more preferably 0.044.

### 1-5-4. Expression (4)

In the zoom lens, it is preferable that at least one of the positive lenses included in the object side portion group satisfies the following Expression (4).

$$70.4 < vd 3 A \qquad ( 4 )$$

Where,

νd3A is Abbe number with respect to d-line of positive lens included in the third lens group.

Expression (4) defines the Abbe number with respect to the d-line of the positive lens included in the object side portion group. In the case that the object side portion group includes the positive lens satisfying Expression (4), the axial chromatic aberration can better be corrected, and the high optical performance can easily be realized while the zoom lens is constructed with the small number of lenses.

On the other hand, when all the Abbe numbers with respect to the d-line of the positive lenses included in the object side portion group become equal to or less than the lower limit value of Expression (4), the aberration correction balance with the image side portion group in the third lens group deteriorates, and it becomes difficult to satisfactorily correct the axial chromatic aberration in the third lens group.

In order to obtain the above effect, the lower limit value of Expression (4) is more preferably 75.4 and still more preferably 81.6.

### 1-5-5. Expression (5)

When the second lens group includes the vibration-compensation group, it is preferable to satisfy the following Expression (5).

$$1.75 < f 2 V / f 2 < 2.82 \qquad ( 5 )$$

Where,

f2V is a focal length of vibration-compensation group; and

f2 is a focal length of the second lens group.

Expression (5) defines a ratio between the focal length of the vibration-compensation group and the focal length of the second lens group. By satisfying Expression (5), it is possible to effectively suppress deterioration of optical performance when image blurring correction is performed. In addition, it is possible to suppress variations in various aberrations at the time of magnification change. From these, even when image blurring correction is performed, high optical performance can be realized in the entire magnification range.

On the other hand, when the numerical value of Expression (5) is equal to or more than the upper limit value, the refractive power of the second lens group becomes stronger than the refractive power of the vibration-compensation group beyond the appropriate range. Therefore, it is difficult to suppress various aberrations at the time of magnification change, particularly fluctuation of spherical aberration. On the other hand, when the numerical value of Expression (5) is less than or equal to the lower limit value, the refractive power of the vibration-compensation group exceeds an appropriate range, and becomes stronger than the refractive power of the second lens group. Therefore, it is difficult to correct eccentric coma aberration at the time of image blurring correction.

In order to obtain the above effect, the upper limit value of Expression (5) is more preferably 2.69 and still more preferably 2.64. The lower limit value of Expression (5) is more preferably 1.84 and still more preferably 1.88.

### 1-5-6. Expression (6)

$$2.38 < f 1 / fw < 3.34 \qquad ( 6 )$$

Where,

f1 is a focal length of the first lens group; and

fw is a focal length of the zoom lens at the wide-angle end.

Expression (6) defines a ratio between the focal length of the first lens group and the focal length of the zoom lens at the wide-angle end. By satisfying Expression (6), the focal length of the first lens group falls within an appropriate range, and the overall optical length of the zoom lens at the wide-angle end can be shortened. By satisfying Expression (6), it is possible to reduce the diameter and weight of the first lens group. Since the outer diameter of the first lens group is larger than that of the other lens groups, by reducing the diameter of the first lens group, the other lens groups can also be reduced in diameter, and the entire zoom lens can be reduced in diameter and weight. In addition, since the overall optical length at the wide-angle end is shortened, the zoom lens can be accommodated in a state where the overall length is shortened when the zoom lens is not used.

On the other hand, when the numerical value of Expression (6) is equal to or more than the upper limit value, the focal length of the first lens group becomes longer than an appropriate range, and the overall optical length of the zoom lens at the wide-angle end becomes longer. In addition, since the refractive power of the first lens group becomes weak beyond an appropriate range, the amount of sending out the first lens group from the wide-angle end toward the telephoto end at the time of magnification change increases in order to realize a high magnification ratio. Therefore, the overall optical length at the telephoto end also becomes long, and it becomes difficult to downsize the entire zoom lens. On the other hand, when the numerical value of Expression (6) is less than or equal to the lower limit value, the focal length of the first lens group becomes shorter than an appropriate range. In this case, it is advantageous in shortening the overall optical length of the zoom lens. However, since the refractive power of the first lens group increases, various aberrations generated in the first lens group increase. Therefore, the number of lenses required for aberration correction increases in order to obtain good optical performance in the full magnification range, and as a result, it becomes difficult to miniaturize the zoom lens.

In order to obtain the above effect, the upper limit value of Expression (6) is more preferably 3.19 and still more preferably 3.13. The lower limit value of Expression (6) is more preferably 2.57 and still more preferably 3.13.

### 1-5-7. Expression (7)

$$- 1.5 < β 2 t < - 0.96 \qquad ( 7 )$$

Where,

β2t is a lateral magnification of the second lens group at the telephoto end.

Expression (7) defines the lateral magnification of the second lens group. By satisfying Expression (7), the movement amount of each lens group at the time of magnification change falls within an appropriate range. In addition, even when the zoom lens is configured with a small number of lenses, various aberrations can be satisfactorily corrected in the entire magnification range. From these, it is possible to achieve miniaturization of the zoom lens while achieving high optical performance.

On the other hand, when the numerical value of Expression (7) becomes equal to or larger than the upper limit value, the lateral magnification of the second lens group becomes smaller than the appropriate range, and in order to realize a predetermined high magnification ratio, it is necessary to compensate for the magnification with the lens group other than the second lens group. Therefore, the movement amount of the other lens group at the time of magnification change becomes large, and the overall optical length becomes long, which makes it difficult to downsize the zoom lens. Alternatively, it is necessary to increase the refractive power of another lens group, and the number of lenses required for correcting various aberrations increases, and in this case, it is also difficult to miniaturize the zoom lens. On the other hand, when the numerical value of Expression (7) becomes equal to or less than the lower limit value, the lateral magnification of the second lens group becomes larger than the appropriate range. In this case, various aberrations generated in the first lens group increase. Therefore, the number of lenses required for aberration correction increases in order to obtain good optical performance in the full magnification range, and as a result, it becomes difficult to miniaturize the zoom lens.

In order to obtain the above effect, the upper limit value of Expression (7) is more preferably −1.01 and still more preferably −1.03. The lower limit value of Expression (7) is more preferably −1.44 and still more preferably −1.03.

### 1-5-8. Expression (8)

$$- 11.01 < ( 1 - β4 {t}^{2} ) \times β 5 {t}^{2} < - 6.89 \qquad ( 8 )$$

Where,

β4t is a lateral magnification of the fourth lens group at the telephoto end; and

β5t is a lateral magnification of the fifth lens group at the telephoto end.

Expression (8) defines focus sensitivity at the telephoto end of the fourth lens group. By satisfying Expression (8), when the fourth lens group is set as a focus group and the fourth lens group is moved in the optical axis direction to perform focusing, aberration fluctuation at the time of focusing can be suppressed to be small, and good imaging performance can be obtained in the entire focusing range regardless of the object distance.

On the other hand, when the numerical value of Expression (8) is equal to or greater than the upper limit value, the focus sensitivity of the fourth lens group decreases. In this case, when the fourth lens group is set as the focus group, the movement amount of the fourth lens group at the time of focusing becomes larger than the appropriate range, so that the overall optical length becomes long, and it becomes difficult to miniaturize the zoom lens. On the other hand, when the numerical value of Expression (8) is less than or equal to the lower limit value, the focus sensitivity of the fourth lens group increases. In this case, aberration fluctuation at the time of focusing increases. Therefore, in order to obtain good imaging performance in the entire focusing range, the number of lenses required for aberration correction increases, and it becomes difficult to miniaturize the zoom lens.

In order to obtain the above effect, the upper limit value of Expression (8) is more preferably −7.27 and still more preferably −7.42. The lower limit value of Expression (8) is more preferably −10.51 and still more preferably −10.31.

### 1-5-9. Expression (9)

$$3.15 < β2 t / β2 w < 4.51 \qquad ( 9 )$$

Where,

β2t is a lateral magnification of the second lens group at the telephoto end; and

β2w is a lateral magnification of the second lens group at the wide-angle end.

Expression (9) defines a ratio between the lateral magnification of the second lens group at the telephoto end and the lateral magnification of the second lens group at the wide-angle end. When Expression (9) is satisfied, the overall optical length can be shortened by optimizing the movement amount of each lens group at the time of magnification change, and various aberrations in the entire zoom region are facilitated, so that the lens configuration can be simplified.

On the other hand, when the numerical value of Expression (9) becomes equal to or larger than the upper limit value, the movement amount of the second lens group at the time of magnification change becomes larger than the appropriate range, so that the overall optical length becomes long, and it becomes difficult to miniaturize the zoom lens. On the other hand, when the numerical value of Expression (9) becomes equal to or less than the lower limit value, the movement amount of the second lens group at the time of magnification change becomes smaller than an appropriate range, and in order to realize a predetermined high magnification ratio, it is necessary to compensate for the magnification change with the lens group other than the second lens group. In this case, the movement amount of the other lens group at the time of magnification change is increased, and the overall optical length of the zoom lens is increased, which makes it difficult to downsize the zoom lens. Alternatively, it is necessary to increase the refractive power of another lens group, and the number of lenses required for correcting various aberrations increases, and in this case, it is also difficult to miniaturize the zoom lens.

In order to obtain the above effect, the upper limit value of Expression (9) is more preferably 4.30 and still more preferably 4.22. The lower limit value of Expression (9) is more preferably 3.32 and still more preferably 3.39.

### 2. Imaging Device

Next, an imaging device according to the present invention will be described. An imaging device according to the present invention includes: the zoom lens according to the present invention; and an image sensor that converts an optical image formed by the zoom lens into an electrical signal. Note that the image sensor is preferably provided on the image side of the zoom lens. Here, the image sensor and the like are not particularly limited, and a solid-state image sensor such as a charge coupled device (CCD) sensor or a complementary metal oxide semiconductor (CMOS) sensor can also be used. The imaging device according to the present invention is suitable for various imaging devices using these solid-state image sensors, such as a digital video camera, a broadcast camera/film camera, a surveillance camera, and an in-vehicle camera.

Furthermore, these imaging devices may be lens fixed imaging devices in which a lens is fixed to a housing, or may be lens interchangeable imaging devices.

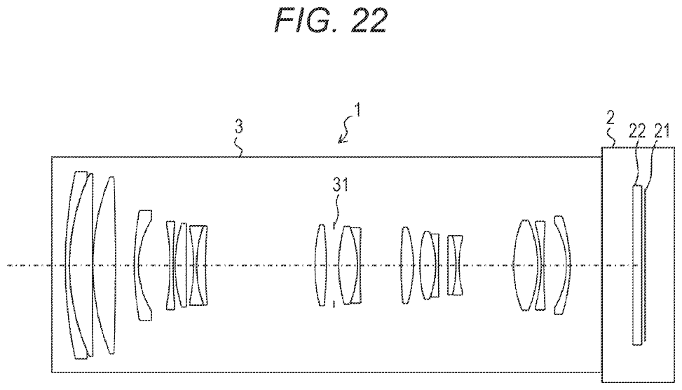

FIG. 22 is a diagram schematically illustrating an example of a configuration of the imaging device. An imaging device 1 includes an imaging device body 2, a lens barrel 3 attached to the imaging device body 2, an image sensor 21 arranged on an image side of the zoom lens, and a cover glass 22 arranged on an object side of the image sensor 21. The zoom lens according to the present invention, an aperture diaphragm 31, a drive mechanism for driving the lens group at the time of magnification change, focusing, and vibration isolation, and the like are accommodated in the lens barrel 3.

Next, the present invention will be specifically described with reference to examples. However, the present invention is not limited to the following examples.

### Example 1

### (1) Optical Configuration

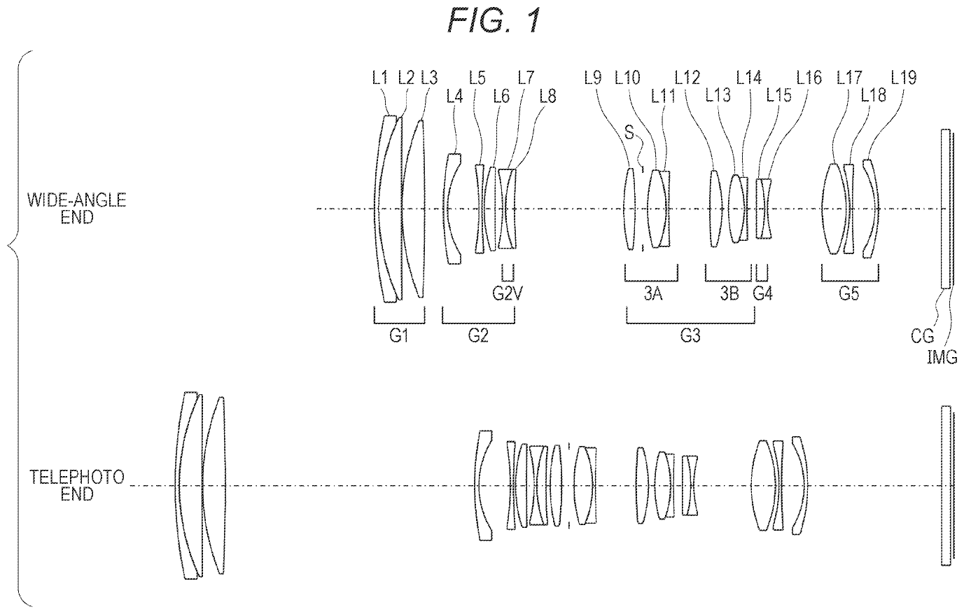

FIG. 1 is a cross-sectional view of a zoom lens according to Example 1 of the present invention during infinity focus; The upper part shows a wide-angle end state, and the lower part shows a telephoto end state. The zoom lens includes, in order from the object side, a first lens group G1 having positive refractive power, a second lens group G2 having negative refractive power, a third lens group G3 having positive refractive power, a fourth lens group G4 having negative refractive power, and a fifth lens group G5 having negative refractive power. The second lens group G2 includes a vibration-compensation group G2V, and the third lens group includes an object side portion group 3A and an image side portion group 3B. An air interval between the object side portion group 3A and the image side portion group 3B is the largest in the third lens group G3. An aperture diaphragm S is disposed in the object side portion group 3A. Hereinafter, the configuration of each lens group will be described.

The first lens group G1 includes a cemented lens in which a negative meniscus lens L1 convex toward the object side and a positive meniscus lens L2 convex toward the object side are cemented in order from the object side, and a biconvex lens L3.

The second lens group G2 includes, in order from the object side, a negative meniscus lens L4 convex toward the object side, a biconcave lens L5, positive meniscus lens 16 convex toward the object side, and a cemented lens in which a biconcave lens L7 and a positive meniscus lens 18 convex toward the object side are cemented. This cemented lens constitutes the vibration-compensation group G2V.

As described above, the third lens group G3 includes the object side portion group 3A and the image side portion group 3B. The object side portion group 3A includes a biconvex lens L9 and a cemented lens in which a biconvex lens L10 and a biconcave lens L11 are cemented. An aperture diaphragm S is disposed between the biconvex lens L9 and the cemented lens. The biconvex lens L10 satisfies the above Expression (4).

The image side portion group 3B includes a biconvex lens L12, and a cemented lens in which a biconvex lens L13 and a biconcave lens L14 are cemented in order from the object side. The biconvex lens L12 satisfies both Expressions (1) and (2).

The fourth lens group G4 includes a cemented lens in which a biconvex lens L15 and a biconcave lens L16 are cemented in order from the object side.

The fifth lens group G5 includes, in order from the object side, a biconvex lens L17, a biconcave lens L18, and a negative meniscus lens L19 concave to the object side.

When the magnification is changed from the wide-angle end to the telephoto end, the first lens group G1 moves to the object side, the second lens group G2 moves to the image side, and the third lens group G3, the fourth lens group G4, and the fifth lens group G5 move to the object side by different movement amounts. In focusing from infinity to a near-distance object, the fourth lens group G4 moves to the image side. When correcting image blurring based on camera shake or the like at the time of imaging, the vibration-compensation group G2V is moved in a direction perpendicular to the optical axis.

Note that, in FIG. 1, “IMG” represents an image plane, and specifically represents an imaging plane of an image sensor such as a CCD sensor or a CMOS sensor, a film plane of a silver salt film, or the like. “CG” indicates a cover glass or the like. These points are similar in each lens cross-sectional view shown in other examples, and thus the description thereof will be omitted below.

### (2) Numerical Examples

Next, numerical examples to which specific numerical values of the zoom lens are applied will be described. Hereinafter, the “surface data”, the “specification”, and the “variable interval” will be described. The values corresponding to the respective conditional expressions are shown in Table 1. Table 1 follows Example 7.

In the “surface data”, “surface number” is the order of the lens surface counted from the object side, “R” is the curvature radius of the lens surface, “D” is the lens thickness or the air interval on the optical axis, “nd” is the refractive index at the d-line, and “νd” is the Abbe number at the d-line. In the column of “surface number”, “ASPH” next to the surface number indicates that the surface is an aspherical surface, and “STOP” indicates that the surface is an aperture diaphragm. Furthermore, in the field of “D”, “D(5)” means a variable interval in which the interval on the optical axis of the lens surface changes. “inf” in the field of the radius of curvature means infinity, and means that the surface is a flat surface.

In “specifications”, “f” indicates a focal length of the zoom lens, “FNO” indicates an F value, “ω” indicates a half angle of view, and indicates respective values at a wide-angle end, an intermediate focal position, and a telephoto end.

The “variable interval” indicates respective values at the wide-angle end, the intermediate focal position, and the telephoto end for each variable interval indicated in the surface data.

Since the matters in these numerical examples are the same in other examples, the description thereof will be omitted below.

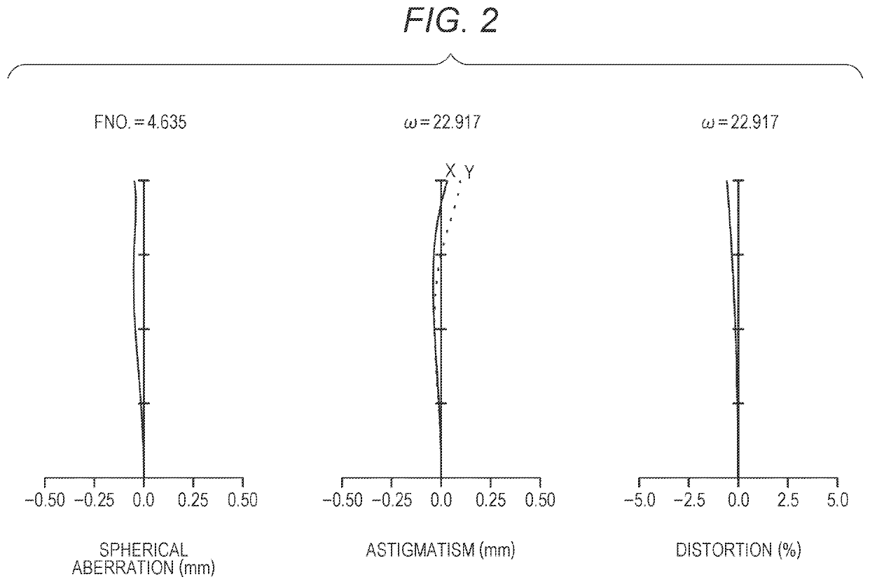

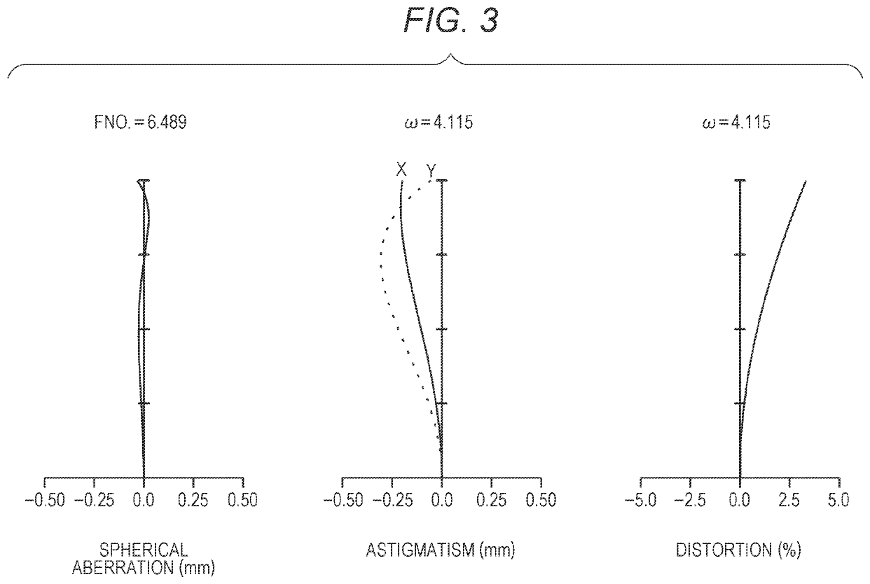

FIGS. 2 and 3 illustrate longitudinal aberration diagrams of the zoom lens at the wide-angle end and the telephoto end during infinity focus. The longitudinal aberration diagrams illustrated in the drawings include spherical aberration (mm), astigmatism (mm), and distortion (%) in order from the left side. The spherical aberration diagram illustrates the characteristic of the d-line. In the astigmatism diagram, the vertical axis represents a half angle of view (w), the horizontal axis indicates defocus, the solid line represents a sagittal image plane (in the drawing, indicated by X) of the d-line, and the broken line represents a meridional image plane (in the drawing, indicted by Y) of the d-line. In the distortion aberration diagram, the vertical axis represents the half angle of view (ω), and the horizontal axis represents the distortion aberration. These matters are the same in the aberration diagrams illustrated in other embodiments, and thus the description thereof will be omitted below.

(Surface Data)

| Surface | | | | |
|---|---|---|---|---|
| No. | R | D | nd | νd |
| 1 | 128.000 | 1.200 | 1.804198 | 46.50 |
| 2 | 62.140 | 6.510 | 1.437001 | 95.10 |
| 3 | 2760.000 | 0.150 | | |
| 4 | 67.800 | 6.500 | 1.437001 | 95.10 |
| 5 | −613.900 | D (5) | | |
| 6 | 82.200 | 1.200 | 1.696802 | 55.46 |
| 7 | 24.600 | 9.000 | | |
| 8 | −72.700 | 0.900 | 1.496997 | 81.61 |
| 9 | 170.000 | 0.600 | | |
| 10 | 39.300 | 3.100 | 1.647690 | 33.84 |
| 11 | 470.000 | 2.200 | | |
| 12 | −46.450 | 0.800 | 1.729160 | 54.10 |
| 13 | 32.500 | 2.600 | 1.858833 | 30.00 |
| 14 | 134.300 | D (14) | | |
| 15 | 49.600 | 3.250 | 1.691002 | 54.82 |
| 16 | −105.300 | 2.200 | | |
| 17STOP | inf | 1.400 | | |
| 18 | 41.460 | 5.310 | 1.496997 | 81.61 |
| 19 | −29.000 | 0.800 | 1.903658 | 31.31 |
| 20 | 300.000 | 11.700 | | |
| 21 | 130.700 | 3.500 | 1.720467 | 34.71 |
| 22 | −36.600 | 1.810 | | |
| 23 | 35.200 | 4.560 | 1.540720 | 47.20 |
| 24 | −27.100 | 0.800 | 1.950000 | 29.37 |
| 25 | 207.000 | D (25) | | |
| 26 | 2217.600 | 2.400 | 1.921189 | 23.96 |
| 27 | −34.270 | 0.800 | 1.799520 | 42.24 |
| 28 | 28.500 | D (28) | | |
| 29 | 35.500 | 6.900 | 1.575006 | 41.51 |
| 30 | −32.500 | 1.000 | | |
| 31 | −41.890 | 0.800 | 1.900433 | 37.37 |
| 32 | 208.500 | 6.440 | | |
| 33 | −23.400 | 1.000 | 1.870705 | 40.73 |
| 34 | −44.740 | D (34) | | |
| 35 | inf | 2.500 | 1.516798 | 64.20 |
| 36 | inf | 1.000 | | |

(Specifications)

| | Wide-angle | Inter- | Telephoto |
|---|---|---|---|
| | end | mediate | end |
| f | 51.5094 | 149.9986 | 290.8673 |
| FNO | 4.6350 | 5.5670 | 6.4890 |
| ω | 22.9165 | 7.8372 | 4.1151 |
| Image | 21.6330 | 21.6330 | 21.6330 |
| height | | | |

(Variable interval)

| | Wide-angle | Inter- | Telephoto |
|---|---|---|---|
| | end | mediate | end |
| D (5) | 5.3235 | 48.3564 | 71.4334 |
| D (14) | 31.2606 | 5.4903 | 1.2000 |
| D (25) | 2.6417 | 10.5699 | 2.5627 |
| D (28) | 15.6249 | 12.6338 | 16.5133 |
| D (34) | 18.0000 | 22.7775 | 38.3792 |

### Example 2

### (1) Optical Configuration

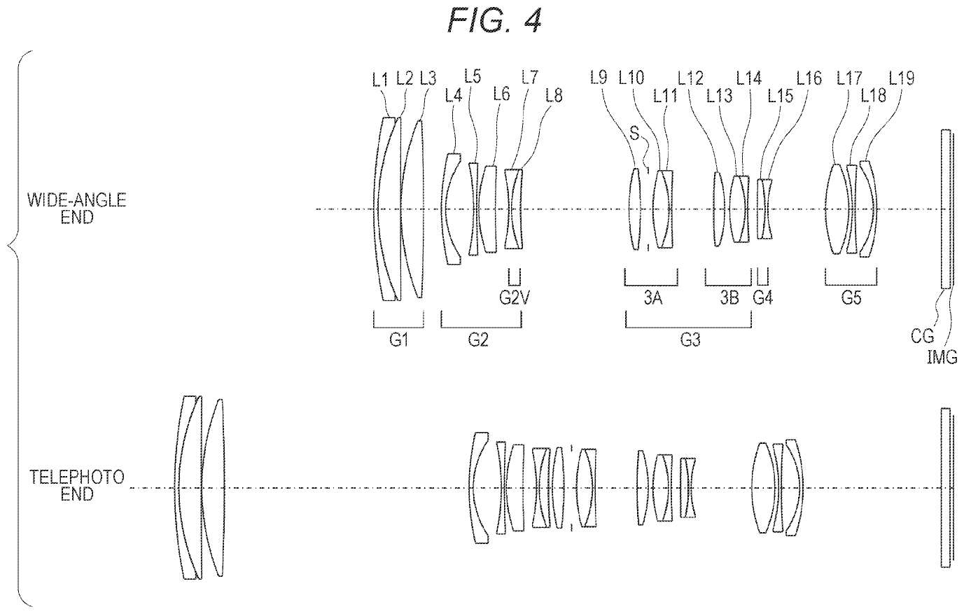

FIG. 4 is a cross-sectional view of a zoom lens according to Example 2 of the present invention at a wide-angle end during infinity focus. The zoom lens includes, in order from the object side, a first lens group G1 having positive refractive power, a second lens group G2 having negative refractive power, a third lens group G3 having positive refractive power, a fourth lens group G4 having negative refractive power, and a fifth lens group G5 having negative refractive power. The second lens group G2 includes a vibration-compensation group G2V, and the third lens group includes an object side portion group 3A and an image side portion group 3B. An air interval between the object side portion group 3A and the image side portion group 3B is the largest in the third lens group G3. An aperture diaphragm S is disposed in the object side portion group 3A. Hereinafter, the configuration of each lens group will be described.

The first lens group G1 includes a cemented lens in which a negative meniscus lens L1 convex toward the object side and a positive meniscus lens L2 convex toward the object side are cemented in order from the object side, and a biconvex lens L3.

The second lens group G2 includes, in order from the object side, a negative meniscus lens L4 convex toward the object side, a biconcave lens L5, positive meniscus lens L6 convex toward the object side, and a cemented lens in which a biconcave lens L7 and a positive meniscus lens L8 convex toward the object side are cemented. This cemented lens constitutes the vibration-compensation group G2V.

As described above, the third lens group G3 includes the object side portion group 3A and the image side portion group 3B. The object side portion group 3A includes a biconvex lens 19 and a cemented lens in which a biconvex lens L10 and a biconcave lens L11 are cemented. An aperture diaphragm S is disposed between the biconvex lens L9 and the cemented lens. The biconvex lens L10 satisfies the above Expression (4).

The image side portion group 3B includes a biconvex lens L12, and a cemented lens in which a biconvex lens L13 and a biconcave lens L14 are cemented in order from the object side. The biconvex lens L12 satisfies both Expressions (1) and (2).

The fourth lens group G4 includes a cemented lens in which a biconvex lens L15 and a biconcave lens L16 are cemented in order from the object side.

The fifth lens group G5 includes, in order from the object side, a biconvex lens L17, a biconcave lens L18, and a negative meniscus lens L19 concave to the object side.

When the magnification is changed from the wide-angle end to the telephoto end, the first lens group G1 moves to the object side, the second lens group G2 moves to the image side, and the third lens group G3, the fourth lens group G4, and the fifth lens group G5 move to the object side by different movement amounts. In focusing from infinity to a near-distance object, the fourth lens group G4 moves to the image side. When correcting image blurring based on camera shake or the like at the time of imaging, the vibration-compensation group G2V is moved in a direction perpendicular to the optical axis.

### (2) Numerical Examples

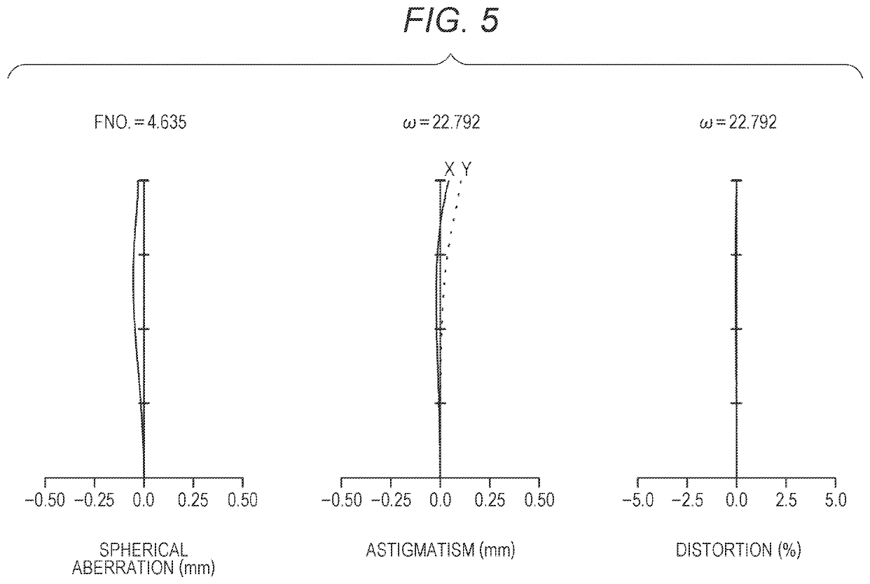

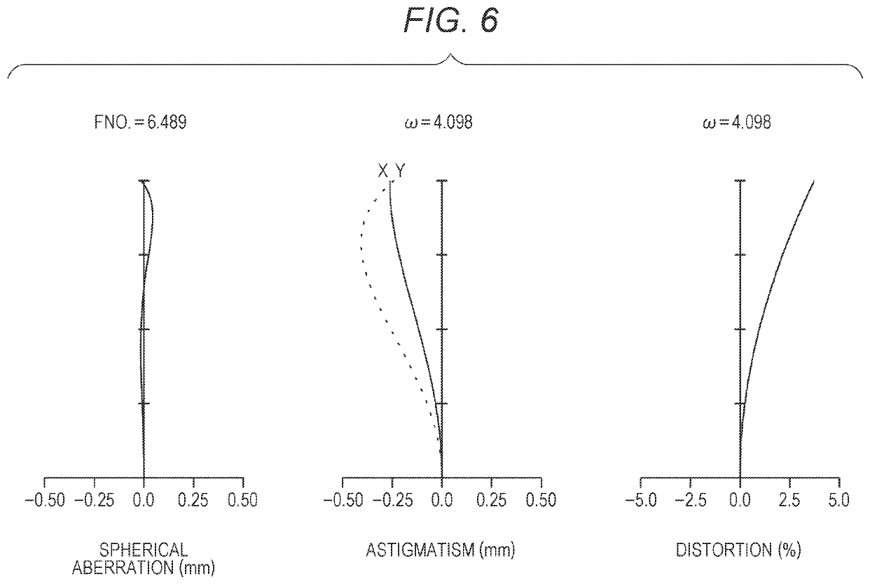

Next, numerical examples to which specific numerical values of the zoom lens are applied will be described. Values corresponding to the respective conditional expressions are shown in Table 1 below. FIGS. 5 and 6 illustrate longitudinal aberration diagrams of the zoom lens at the wide-angle end and the telephoto end during infinity focus.

(Surface Data)

| Surface No. | R | D | nd | νd |
|---|---|---|---|---|
| 1 | 129.142 | 1.200 | 1.804198 | 46.50 |
| 2 | 62.453 | 6.434 | 1.437001 | 95.10 |
| 3 | 2951.926 | 0.150 | | |
| 4 | 68.839 | 6.463 | 1.437001 | 95.10 |
| 5 | −534.675 | D (5) | | |
| 6 | 68.952 | 1.200 | 1.696802 | 55.46 |
| 7 | 24.197 | 8.000 | | |
| 8 | −64.651 | 0.900 | 1.496997 | 81.61 |
| 9 | 327.679 | 0.588 | | |
| 10 | 37.904 | 4.711 | 1.647690 | 33.84 |
| 11 | 204.409 | 3.917 | | |
| 12 | −46.436 | 0.760 | 1.729160 | 54.10 |
| 13 | 31.162 | 2.587 | 1.858833 | 30.00 |
| 14 | 123.684 | D (14) | | |
| 15 | 49.692 | 3.281 | 1.691002 | 54.82 |
| 16 | −93.891 | 2.200 | | |
| 17STOP | inf | 1.400 | | |
| 18 | 41.325 | 4.557 | 1.496997 | 81.61 |
| 19 | −29.055 | 0.800 | 1.903658 | 31.31 |
| 20 | 256.941 | 12.004 | | |
| 21 | 140.393 | 3.176 | 1.720467 | 34.71 |
| 22 | −36.208 | 1.384 | | |
| 23 | 35.304 | 4.402 | 1.567320 | 42.84 |
| 24 | −27.633 | 0.800 | 1.950000 | 29.37 |
| 25 | 137.742 | D (25) | | |
| 26 | 373.826 | 2.235 | 1.921189 | 23.96 |
| 27 | −40.675 | 0.800 | 1.799520 | 42.24 |
| 28 | 29.168 | D (28) | | |
| 29 | 37.478 | 6.678 | 1.575006 | 41.51 |
| 30 | −32.083 | 1.000 | | |
| 31 | −45.856 | 0.800 | 1.900433 | 37.37 |
| 32 | 178.975 | 5.220 | | |
| 33 | −21.685 | 1.000 | 1.870705 | 40.73 |
| 34 | −43.395 | D (34) | | |
| 35 | inf | 2.500 | 1.516798 | 64.20 |
| 36 | inf | 1.000 | | |

(Specifications)

| | Wide-angle | | |
|---|---|---|---|
| | end | Intermediate | Telephoto end |
| f | 51.5254 | 150.0304 | 290.8948 |
| FNO | 4.6350 | 5.7677 | 6.4890 |
| ω | 22.7921 | 7.8355 | 4.0980 |
| Image height | 21.6330 | 21.6330 | 21.6330 |

(Variable interval)

| | Wide-angle | | |
|---|---|---|---|
| | end | Intermediate | Telephoto end |
| D (5) | 5.1089 | 46.9929 | 70.0570 |
| D (14) | 31.0382 | 6.9612 | 1.2000 |
| D (25) | 2.7007 | 9.5863 | 2.6856 |
| D (28) | 16.5071 | 12.6452 | 17.3384 |
| D (34) | 18.4979 | 26.6987 | 39.5668 |

### Example 3

### (1) Optical Configuration

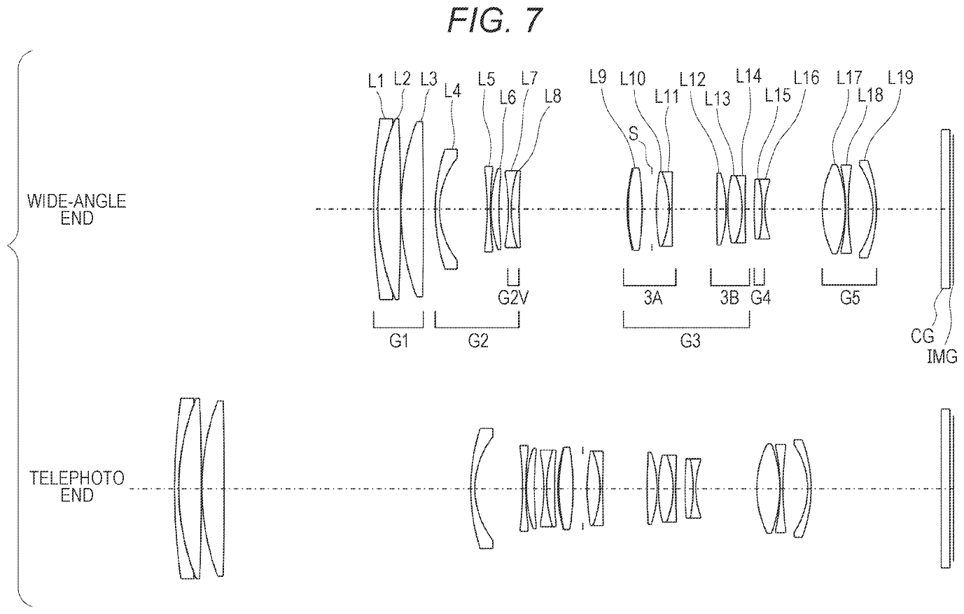

FIG. 7 is a cross-sectional view of a zoom lens according to Example 3 of the present invention at a wide-angle end during infinity focus. The zoom lens includes, in order from the object side, a first lens group G1 having positive refractive power, a second lens group G2 having negative refractive power, a third lens group G3 having positive refractive power, a fourth lens group G4 having negative refractive power, and a fifth lens group G5 having negative refractive power. The second lens group G2 includes a vibration-compensation group G2V, and the third lens group includes an object side portion group 3A and an image side portion group 3B. An air interval between the object side portion group 3A and the image side portion group 3B is the largest in the third lens group G3. An aperture diaphragm S is disposed in the object side portion group 3A. Hereinafter, the configuration of each lens group will be described.

The first lens group G1 includes, in order from the object side, a cemented lens in which the negative meniscus lens L1 and the biconvex lens L2 convex toward the object side are cemented, and the biconvex lens L3. The second lens group G2 includes, in order from the object side, a negative meniscus lens L4 convex toward the object side, a biconcave lens L5, positive meniscus lens L6 convex toward the object side, and a cemented lens in which a biconcave lens L7 and a positive meniscus lens 18 convex toward the object side are cemented. This cemented lens constitutes the vibration-compensation group G2V.

As described above, the third lens group G3 includes the object side portion group 3A and the image side portion group 3B. The object side portion group 3A includes a biconvex lens L9 and a cemented lens in which a biconvex lens L10 and a biconcave lens L11 are cemented. An aperture diaphragm S is disposed between the biconvex lens L9 and the cemented lens. The biconvex lens L10 satisfies the above Expression (4). The biconvex lens L9 is a composite aspheric lens in which a resin aspheric sheet is provided on an object side surface of a glass material lens.

The image side portion group 3B includes a biconvex lens L12, and a cemented lens in which a biconvex lens L13 and a biconcave lens L14 are cemented in order from the object side. The biconvex lens L12 and the biconvex lens L13 satisfy both Expressions (1) and (2). In the following Table 1, Expressions (1) and (2) first indicate corresponding values of the biconvex lens L12, and Expressions (1) and (2) next indicate corresponding values of the biconvex lens L13. Also in the following examples, in a case where a plurality of lenses satisfying both Expressions (1) and (2) are included, Table 1 shows the corresponding values in the order of arrangement from the object side.

The fourth lens group G4 includes a cemented lens in which a biconvex lens L15 and a biconcave lens L16 are cemented in order from the object side.

The fifth lens group G5 includes, in order from the object side, a biconvex lens L17, a biconcave lens L18, and a negative meniscus lens L19 concave to the object side.

When the magnification is changed from the wide-angle end to the telephoto end, the first lens group G1 moves to the object side, the second lens group G2 moves to the image side, and the third lens group G3, the fourth lens group G4, and the fifth lens group G5 move to the object side by different movement amounts. In focusing from infinity to a near-distance object, the fourth lens group G4 moves to the image side. When correcting image blurring based on camera shake or the like at the time of imaging, the vibration-compensation group G2V is moved in a direction perpendicular to the optical axis.

### (2) Numerical Examples

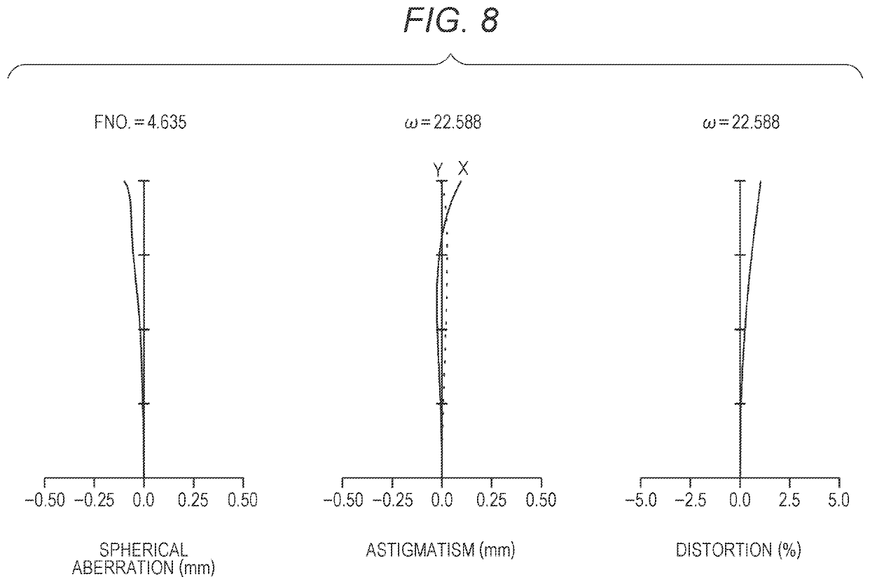

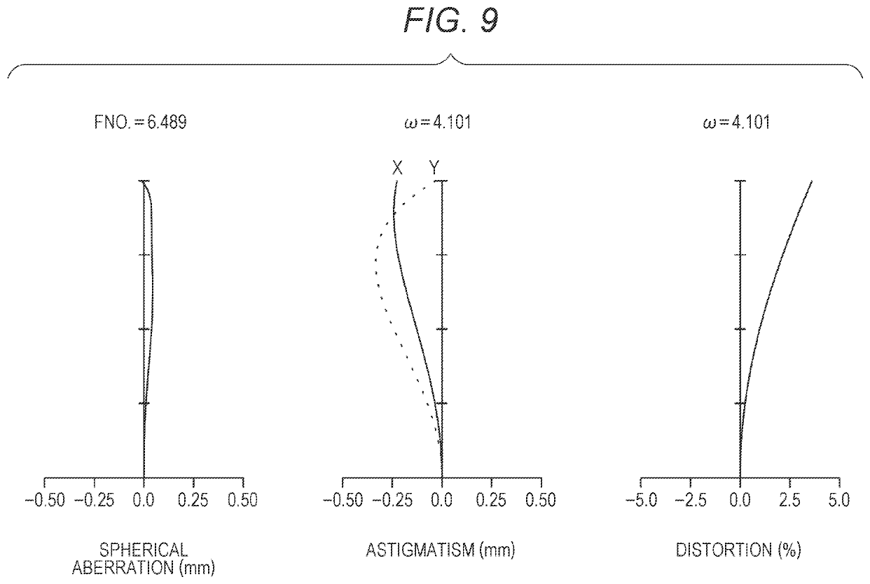

Next, numerical examples to which specific numerical values of the zoom lens are applied will be described. Values corresponding to the respective conditional expressions are shown in Table 1 below. FIGS. 8 and 9 illustrate longitudinal aberration diagrams of the zoom lens at the wide-angle end and the telephoto end during infinity focus.

However, in the zoom lens according to Example 3, the fifteenth surface is aspherical. The values of the coefficients when the aspheric surface is defined by the following expression are shown in the following “aspherical surface data”. The same applies to the aspherical surface data shown in Example 4 and Example 5, and thus the description thereof will be omitted.

$${z = {ch}^{2} / [ 1 + ( 1 - ( 1 + k ) {c}^{2} {h}^{2} \}}^{1 / 2} ] + A 4 {h}^{4} + A 6 {h}^{6} + A 8 {h}^{8} + A 10 {h}^{10} + A 12 {h}^{12} …$$

(Here, c represents a curvature (1/r), h represents a height from the optical axis, k represents a conic coefficient, A4, A6, A8, A10, A12 represent aspheric surface coefficients of each order)

(Surface Data)

| Surface No. | R | D | nd | νd |
|---|---|---|---|---|
| 1 | 183.210 | 1.2000 | 1.785897 | 43.93 |
| 2 | 69.425 | 6.5488 | 1.437001 | 95.10 |
| 3 | −569.593 | 0.1000 | | |
| 4 | 72.457 | 6.3878 | 1.496997 | 81.61 |
| 5 | −1226.359 | D(5) | | |
| 6 | 55.752 | 1.2000 | 1.651599 | 58.40 |
| 7 | 23.877 | 13.6303 | | |
| 8 | −98.146 | 0.9000 | 1.496997 | 81.61 |
| 9 | 90.823 | 0.2336 | | |
| 10 | 35.691 | 2.2335 | 1.654115 | 39.68 |
| 11 | 93.395 | 2.7435 | | |
| 12 | −51.355 | 0.8000 | 1.772500 | 49.62 |
| 13 | 36.535 | 2.2467 | 1.921189 | 23.96 |
| 14 | 146.611 | D(14) | | |
| 15ASPH | 45.983 | 0.2179 | 1.536000 | 41.21 |
| 16 | 45.504 | 4.0676 | 1.733999 | 51.05 |
| 17 | −78.586 | 2.8183 | | |
| 18STOP | inf | 1.2392 | | |
| 19 | 60.940 | 3.6855 | 1.496997 | 81.61 |
| 20 | −28.426 | 0.8000 | 1.901102 | 27.06 |
| 21 | 409.051 | 12.7672 | | |
| 22 | 256.818 | 2.7662 | 1.720467 | 34.71 |
| 23 | −33.625 | 0.4268 | | |
| 24 | 43.535 | 4.1461 | 1.603420 | 38.01 |
| 25 | −26.462 | 0.8000 | 1.950000 | 29.37 |
| 26 | 239.563 | D(26) | | |
| 27 | 117.323 | 2.2800 | 1.921189 | 23.96 |
| 28 | −45.681 | 0.8000 | 1.804200 | 46.50 |
| 29 | 24.188 | D(29) | | |
| 30 | 29.038 | 6.5834 | 1.540720 | 47.20 |
| 31 | −35.305 | 0.1000 | | |
| 32 | −55.742 | 0.8000 | 1.953747 | 32.32 |
| 33 | 89.313 | 7.0638 | | |
| 34 | −22.354 | 1.0000 | 1.881003 | 40.14 |
| 35 | −39.540 | D(35) | | |
| 36 | inf | 2.5000 | 1.516798 | 64.20 |
| 37 | inf | 1.0000 | | |

(Specifications)

| | Wide-angle end | Intermediate | Telephoto end |
|---|---|---|---|
| f | 51.5193 | 149.9389 | 290.8687 |
| FNO | 4.6350 | 5.8106 | 6.4890 |
| ω | 22.5879 | 7.8478 | 4.1010 |
| Image height | 21.6330 | 21.6330 | 21.6330 |

(Variable interval)

| | Wide-angle end | Intermediate | Telephoto end |
|---|---|---|---|
| D (5) | 3.4369 | 45.9794 | 70.5571 |
| D (14) | 30.9387 | 7.2451 | 1.0000 |
| D (26) | 2.6057 | 9.1116 | 2.6613 |
| D (29) | 16.4117 | 12.1326 | 17.4430 |
| D (35) | 18.5208 | 27.9046 | 37.2523 |

(Aspheric surface coefficient)

| Surface | | | | | | |
|---|---|---|---|---|---|---|
| number | K | A4 | A6 | A8 | A10 | A12 |
| 15 | 0.00000 | −2.85352E−06 | −3.54533E−10 | 3.31138E−11 | −3.95098E−13 | 1.39435E−15 |

### Example 4

### (1) Optical Configuration

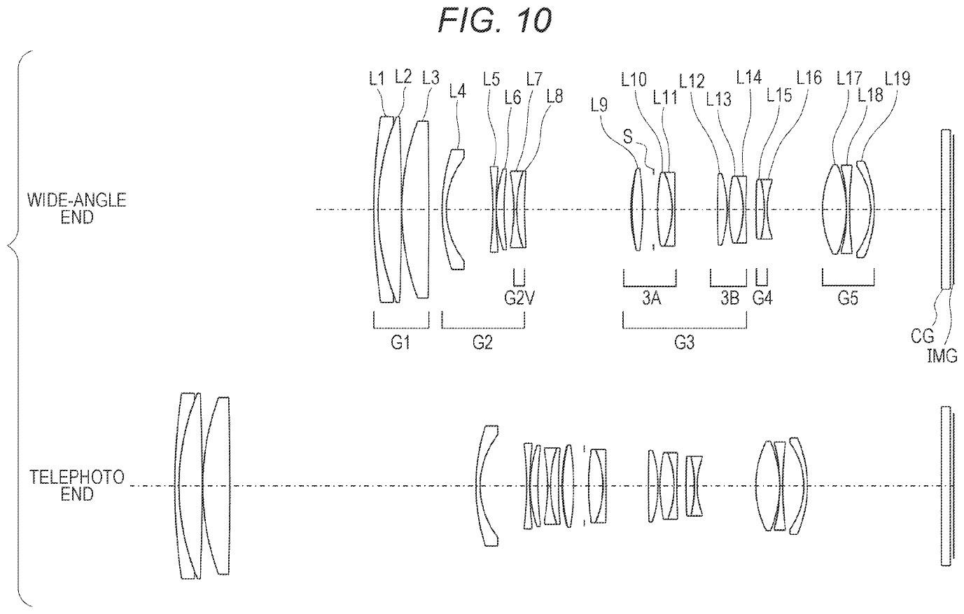

FIG. 10 is a cross-sectional view of the zoom lens according to Example 4 of the present invention at a wide-angle end during infinity focus; The zoom lens includes, in order from the object side, a first lens group G1 having positive refractive power, a second lens group G2 having negative refractive power, a third lens group G3 having positive refractive power, a fourth lens group G4 having negative refractive power, and a fifth lens group G5 having negative refractive power. The second lens group G2 includes a vibration-compensation group G2V, and the third lens group includes an object side portion group 3A and an image side portion group 3B. An air interval between the object side portion group 3A and the image side portion group 3B is the largest in the third lens group G3. An aperture diaphragm S is disposed in the object side portion group 3A. Hereinafter, the configuration of each lens group will be described.

The first lens group G1 includes, in order from the object side, a cemented lens in which the negative meniscus lens L1 and the biconvex lens L2 convex toward the object side are cemented, and the biconvex lens L3.

The second lens group G2 includes, in order from the object side, a negative meniscus lens L4 convex toward the object side, a biconcave lens L5, positive meniscus lens L6 convex toward the object side, and a cemented lens in which a biconcave lens L7 and a positive meniscus lens 18 convex toward the object side are cemented. This cemented lens constitutes the vibration-compensation group G2V.

As described above, the third lens group G3 includes the object side portion group 3A and the image side portion group 3B. The object side portion group 3A includes a biconvex lens L9 and a cemented lens in which the biconvex lens L10 and a negative meniscus lens L11 concave to the object side are cemented. An aperture diaphragm S is disposed between the biconvex lens L9 and the cemented lens. The biconvex lens L10 satisfies the above Expression (4). The biconvex lens L9 is a composite aspheric lens in which a resin aspheric sheet is provided on an object side surface of a glass material lens.

The image side portion group 3B includes a biconvex lens L12, and a cemented lens in which a biconvex lens L13 and a biconcave lens L14 are cemented in order from the object side. The biconvex lens L12 and the biconvex lens L13 satisfy both Expressions (1) and (2). The fourth lens group G4 includes a cemented lens in which a biconvex lens L15 and a biconcave lens L16 are cemented in order from the object side.

The fifth lens group G5 includes, in order from the object side, a biconvex lens L17, a biconcave lens L18, and a negative meniscus lens L19 concave to the object side.

When the magnification is changed from the wide-angle end to the telephoto end, the first lens group G1 moves to the object side, the second lens group G2 moves to the image side, and the third lens group G3, the fourth lens group G4, and the fifth lens group G5 move to the object side by different movement amounts. In focusing from infinity to a near-distance object, the fourth lens group G4 moves to the image side. When correcting image blurring based on camera shake or the like at the time of imaging, the vibration-compensation group G2V is moved in a direction perpendicular to the optical axis.

### (2) Numerical Examples

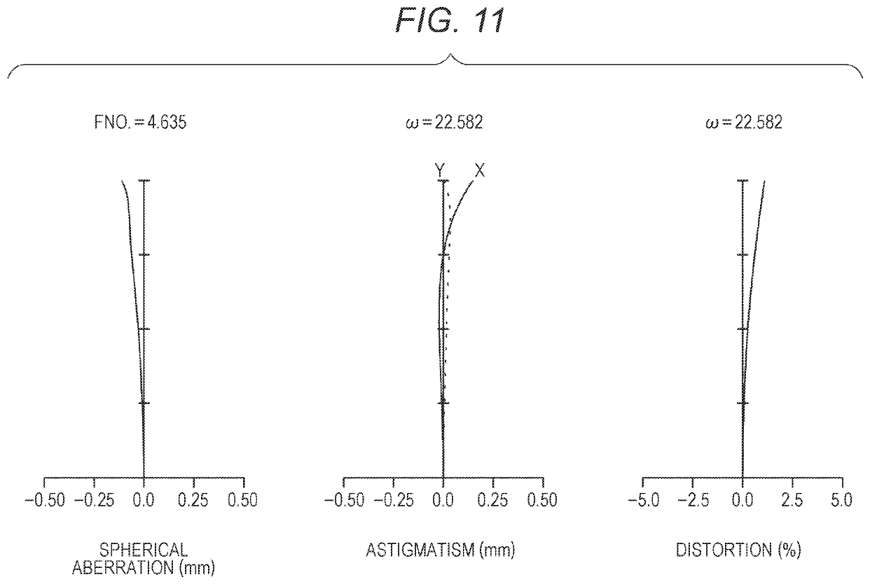

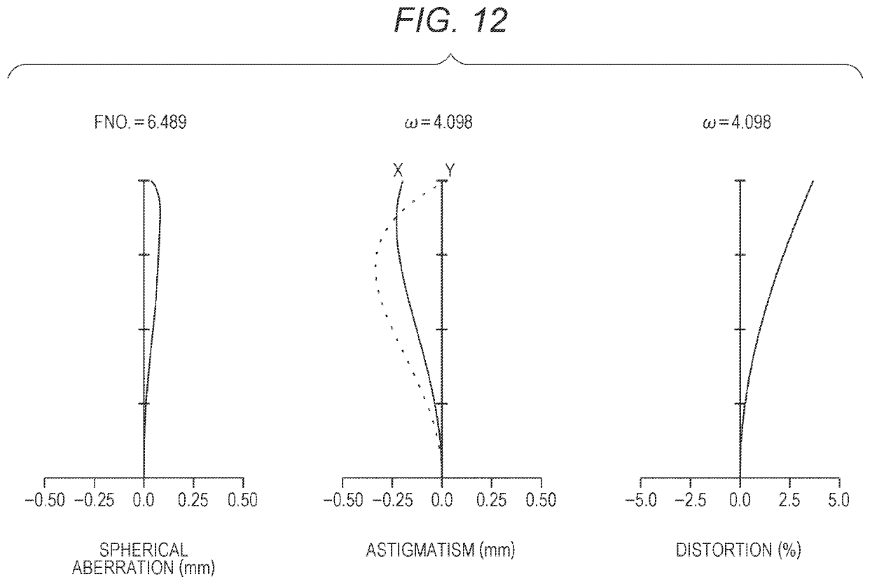

Next, numerical examples to which specific numerical values of the zoom lens are applied will be described. Values corresponding to the respective conditional expressions are shown in Table 1 below. FIGS. 11 and 12 illustrate longitudinal aberration diagrams of the zoom lens at the wide-angle end and the telephoto end during infinity focus.

(Surface Data)

| Surface No. | R | D | nd | νd |
|---|---|---|---|---|
| 1 | 181.565 | 1.2000 | 1.785897 | 43.93 |
| 2 | 69.212 | 6.6958 | 1.437001 | 95.10 |
| 3 | −603.363 | 0.1000 | | |
| 4 | 72.820 | 7.7764 | 1.496997 | 81.61 |
| 5 | −1061.238 | D(5) | | |
| 6 | 55.196 | 1.2000 | 1.651599 | 58.40 |
| 7 | 23.800 | 13.3389 | | |
| 8 | −96.023 | 0.9000 | 1.496997 | 81.61 |
| 9 | 108.318 | 0.1000 | | |
| 10 | 35.046 | 2.1942 | 1.654115 | 39.68 |
| 11 | 82.493 | 2.8251 | | |
| 12 | −51.032 | 0.8000 | 1.772500 | 49.62 |
| 13 | 34.542 | 2.2689 | 1.921189 | 23.96 |
| 14 | 131.328 | D(14) | | |
| 15ASPH | 47.087 | 0.2134 | 1.536000 | 41.21 |
| 16 | 50.891 | 3.1324 | 1.733999 | 51.05 |
| 17 | −75.107 | 3.0720 | | |
| 18STOP | inf | 1.2000 | | |
| 19 | 69.776 | 4.1333 | 1.496997 | 81.61 |
| 20 | −26.449 | 0.8000 | 1.901102 | 27.06 |
| 21 | −3021.613 | 12.2098 | | |
| 22 | 312.299 | 2.7506 | 1.720467 | 34.71 |
| 23 | −33.214 | 0.5401 | | |
| 24 | 44.184 | 4.0526 | 1.654115 | 39.68 |
| 25 | −25.757 | 0.8000 | 1.950000 | 29.37 |
| 26 | 198.416 | D(26) | | |
| 27 | 150.560 | 2.4068 | 1.921189 | 23.96 |
| 28 | −36.560 | 0.8000 | 1.804200 | 46.50 |
| 29 | 23.773 | D(29) | | |
| 30 | 28.755 | 6.8248 | 1.540720 | 47.20 |
| 31 | −32.646 | 0.1000 | | |
| 32 | −47.911 | 0.8000 | 1.953747 | 32.32 |
| 33 | 100.483 | 6.0703 | | |
| 34 | −21.246 | 1.0000 | 1.881003 | 40.14 |
| 35 | −34.701 | D(35) | | |
| 36 | inf | 2.5000 | 1.516798 | 64.20 |
| 37 | inf | 1.0000 | | |

(Specifications)

| | Wide-angle end | Intermediate | Telephoto end |
|---|---|---|---|
| f | 51.5229 | 149.9341 | 290.8444 |
| FNO | 4.6350 | 5.8241 | 6.4890 |
| ω | 22.5823 | 7.8527 | 4.0977 |
| Image height | 21.6330 | 21.6330 | 21.6330 |

(Variable interval)

| | Wide-angle end | Intermediate | Telephoto end |
|---|---|---|---|
| D (5) | 3.7624 | 44.9010 | 70.4440 |
| D (14) | 30.4744 | 6.3497 | 1.0000 |
| D (26) | 2.8345 | 9.3798 | 2.6247 |
| D (29) | 15.8607 | 11.7803 | 16.7419 |
| D (35) | 19.2625 | 28.7462 | 38.3839 |

(Aspheric surface coefficient)

| Surface | | | | | | |
|---|---|---|---|---|---|---|
| number | K | A4 | A6 | A8 | A10 | A12 |
| 15 | 0.00000 | −2.85724E−06 | −2.86740E−10 | 3.17766E−11 | −3.63987E−13 | 1.325608−15 |

### Example 5

### (1) Optical Configuration

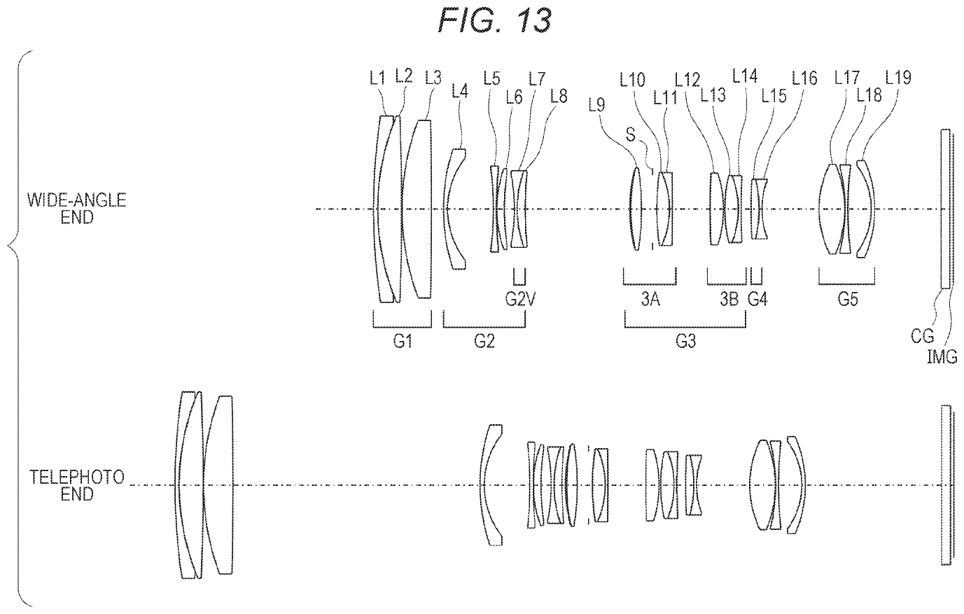

FIG. 13 is a cross-sectional view of the zoom lens according to Example 5 of the present invention at a wide-angle end during infinity focus. The zoom lens includes, in order from the object side, a first lens group G1 having positive refractive power, a second lens group G2 having negative refractive power, a third lens group G3 having positive refractive power, a fourth lens group G4 having negative refractive power, and a fifth lens group G5 having negative refractive power. The second lens group G2 includes a vibration-compensation group G2V, and the third lens group includes an object side portion group 3A and an image side portion group 3B. An air interval between the object side portion group 3A and the image side portion group 3B is the largest in the third lens group G3. An aperture diaphragm S is disposed in the object side portion group 3A. Hereinafter, the configuration of each lens group will be described.

The first lens group G1 includes, in order from the object side, a cemented lens in which the negative meniscus lens L1 and the biconvex lens L2 convex toward the object side are cemented, and the biconvex lens L3.

The second lens group G2 includes, in order from the object side, a negative meniscus lens L4 convex toward the object side, a biconcave lens L5, positive meniscus lens L6 convex toward the object side, and a cemented lens in which a biconcave lens L7 and a positive meniscus lens L8 convex toward the object side are cemented. This cemented lens constitutes the vibration-compensation group G2V.

As described above, the third lens group G3 includes the object side portion group 3A and the image side portion group 3B. The object side portion group 3A includes a biconvex lens L9 and a cemented lens in which the biconvex lens L10 and a negative meniscus lens L11 concave to the object side are cemented. An aperture diaphragm S is disposed between the biconvex lens L9 and the cemented lens. The biconvex lens L10 satisfies the above Expression (4).

The image side portion group 3B includes a biconvex lens L12, and a cemented lens in which a biconvex lens L13 and a biconcave lens L14 are cemented in order from the object side. The biconvex lens L12 and the biconvex lens L13 satisfy both Expressions (1) and (2).

The fourth lens group G4 includes a cemented lens in which a biconvex lens L15 and a biconcave lens L16 are cemented in order from the object side.

The fifth lens group G5 includes, in order from the object side, a biconvex lens L17, a biconcave lens L18, and a negative meniscus lens L19 concave to the object side.

When the magnification is changed from the wide-angle end to the telephoto end, the first lens group G1 moves to the object side, the second lens group G2 moves to the image side, and the third lens group G3, the fourth lens group G4, and the fifth lens group G5 move to the object side by different movement amounts. In focusing from infinity to a near-distance object, the fourth lens group G4 moves to the image side. When correcting image blurring based on camera shake or the like at the time of imaging, the vibration-compensation group G2V is moved in a direction perpendicular to the optical axis.

### (2) Numerical Examples

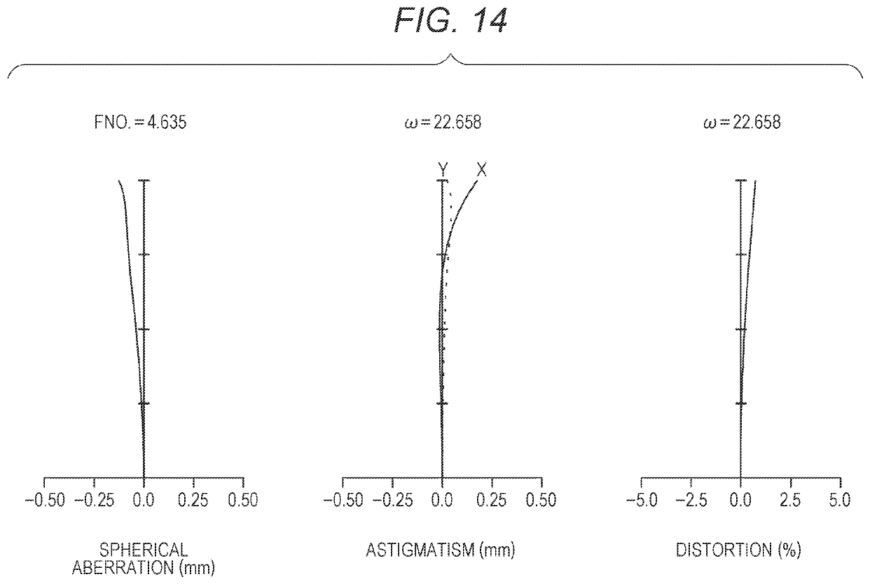

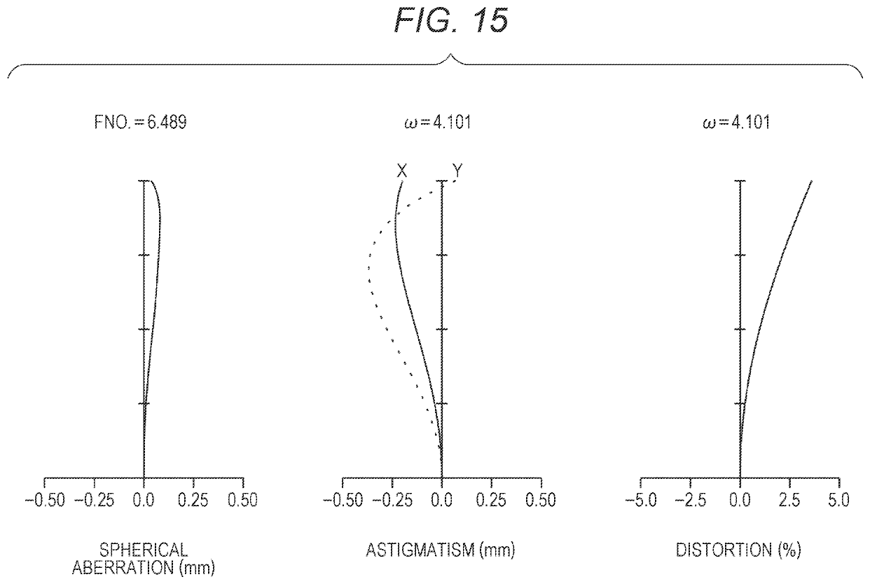

Next, numerical examples to which specific numerical values of the zoom lens are applied will be described. Values corresponding to the respective conditional expressions are shown in Table 1 below. FIGS. 14 and 15 illustrate longitudinal aberration diagrams of the zoom lens at the wide-angle end and the telephoto end during infinity focus.

(Surface Data)

| Surface No. | R | D | nd | νd |
|---|---|---|---|---|
| 1 | 177.749 | 1.2000 | 1.785897 | 43.93 |
| 2 | 68.793 | 6.8689 | 1.437001 | 95.10 |
| 3 | −656.781 | 0.1000 | | |
| 4 | 72.598 | 8.4128 | 1.496997 | 81.61 |
| 5 | −1145.855 | D(5) | | |
| 6 | 54.450 | 1.2000 | 1.651599 | 58.40 |
| 7 | 23.815 | 13.0939 | | |
| 8 | −102.180 | 0.9000 | 1.496997 | 81.61 |
| 9 | 114.180 | 0.1000 | | |
| 10 | 33.969 | 2.1728 | 1.654115 | 39.68 |
| 11 | 73.394 | 2.8809 | | |
| 12 | −52.060 | 0.8000 | 1.772500 | 49.62 |
| 13 | 32.258 | 2.3045 | 1.921189 | 23.96 |
| 14 | 111.789 | D(14) | | |
| 15ASPH | 46.182 | 0.3000 | 1.536000 | 41.21 |
| 16 | 52.957 | 3.0628 | 1.733999 | 51.05 |
| 17 | −76.303 | 3.1739 | | |
| 18STOP | inf | 1.2000 | | |
| 19 | 72.728 | 3.6368 | 1.496997 | 81.61 |
| 20 | −25.978 | 0.8000 | 1.901102 | 27.06 |
| 21 | −751.060 | 10.8620 | | |
| 22 | 352.394 | 3.7765 | 1.766340 | 35.82 |
| 23 | −33.676 | 0.4224 | | |
| 24 | 43.765 | 3.8553 | 1.654115 | 39.68 |
| 25 | −25.919 | 0.8000 | 1.950000 | 29.37 |
| 26 | 180.007 | D(26) | | |
| 27 | 168.810 | 2.3257 | 1.921189 | 23.96 |
| 28 | −34.911 | 0.8000 | 1.804200 | 46.50 |
| 29 | 23.344 | D(29) | | |
| 30 | 28.877 | 7.3352 | 1.540720 | 47.20 |
| 31 | −32.781 | 0.1000 | | |
| 32 | −49.848 | 0.8000 | 1.953747 | 32.32 |
| 33 | 104.128 | 6.6956 | | |
| 34 | −21.134 | 1.0000 | 1.881003 | 40.14 |
| 35 | −34.671 | D(35) | | |
| 36 | inf | 2.5000 | 1.516798 | 64.20 |
| 37 | inf | 1.0000 | | |

(Specifications)

| | Wide-angle end | Intermediate | Telephoto end |
|---|---|---|---|
| f | 51.5235 | 149.9353 | 290.8267 |
| FNO | 4.6350 | 5.6733 | 6.4890 |
| ω | 22.6584 | 7.8335 | 4.1005 |
| Image height | 21.6330 | 21.6330 | 21.6330 |

(Variable interval)

| | Wide-angle end | Intermediate | Telephoto end |
|---|---|---|---|
| D (5) | 3.4099 | 46.3503 | 70.7602 |
| D (14) | 29.9145 | 5.8964 | 1.0000 |
| D (26) | 2.8309 | 9.2657 | 2.5209 |
| D (29) | 16.3576 | 11.5314 | 15.2112 |
| D (35) | 19.0072 | 26.9915 | 39.0277 |

(Aspheric surface coefficient)

| Surface | | | | | | |
|---|---|---|---|---|---|---|
| number | K | A4 | A6 | A8 | A10 | A12 |
| 15 | 0.00000 | −3.14706E−06 | −1.30862E−10 | 2.37939E−11 | −2.91120E−13 | 1.10187E−15 |

### Example 6

### (1) Optical Configuration

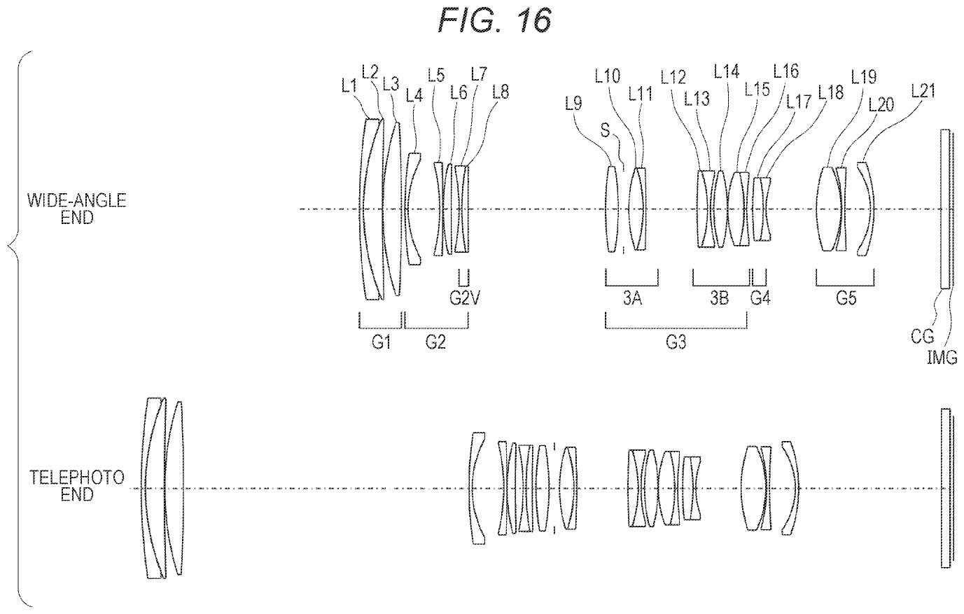

FIG. 16 is a cross-sectional view of the zoom lens according to Example 6 of the present invention at a wide-angle end during infinity focus. The zoom lens includes, in order from the object side, a first lens group G1 having positive refractive power, a second lens group G2 having negative refractive power, a third lens group G3 having positive refractive power, a fourth lens group G4 having negative refractive power, and a fifth lens group G5 having negative refractive power. The second lens group G2 includes a vibration-compensation group G2V, and the third lens group includes an object side portion group 3A and an image side portion group 3B. An air interval between the object side portion group 3A and the image side portion group 3B is the largest in the third lens group G3. An aperture diaphragm S is disposed in the object side portion group 3A. Hereinafter, the configuration of each lens group will be described.

The first lens group G1 includes a cemented lens in which a negative meniscus lens L1 convex toward the object side and a positive meniscus lens L2 convex toward the object side are cemented in order from the object side, and a biconvex lens L3.

The second lens group G2 includes, in order from the object side, a negative meniscus lens L4 convex toward the object side, a negative meniscus lens L5 concave toward the object side, a positive meniscus lens L6 convex toward the object side, and a cemented lens in which a biconcave lens 17 and a positive meniscus lens L8 convex toward the object side are cemented. This cemented lens constitutes the vibration-compensation group G2V.

As described above, the third lens group G3 includes the object side portion group 3A and the image side portion group 3B. The object side portion group 3A includes a biconvex lens L9 and a cemented lens in which the biconvex lens L10 and a negative meniscus lens L11 concave to the object side are cemented. An aperture diaphragm S is disposed between the biconvex lens L9 and the cemented lens. The biconvex lens L10 satisfies the above Expression (4).

The image side portion group 3B includes a cemented lens in which a biconvex lens L12 and a biconcave lens L13 are cemented in order from the object side, a biconvex lens L14, and a cemented lens in which a biconvex lens L15 and a biconcave lens L16 are cemented. The biconvex lens L14 and the biconvex lens L15 satisfy both Expressions (1) and (2).

The fourth lens group G4 includes a cemented lens in which a biconvex lens L17 and a biconcave lens L18 are cemented in order from the object side.

The fifth lens group G5 includes, in order from the object side, a biconvex lens L19, a biconcave lens L20, and a negative meniscus lens L21 concave to the object side.

When the magnification is changed from the wide-angle end to the telephoto end, the first lens group G1 moves to the object side, the second lens group G2 moves to the image side, and the third lens group G3, the fourth lens group G4, and the fifth lens group G5 move to the object side by different movement amounts. In focusing from infinity to a near-distance object, the fourth lens group G4 moves to the image side. When correcting image blurring based on camera shake or the like at the time of imaging, the vibration-compensation group G2V is moved in a direction perpendicular to the optical axis.

### (2) Numerical Examples

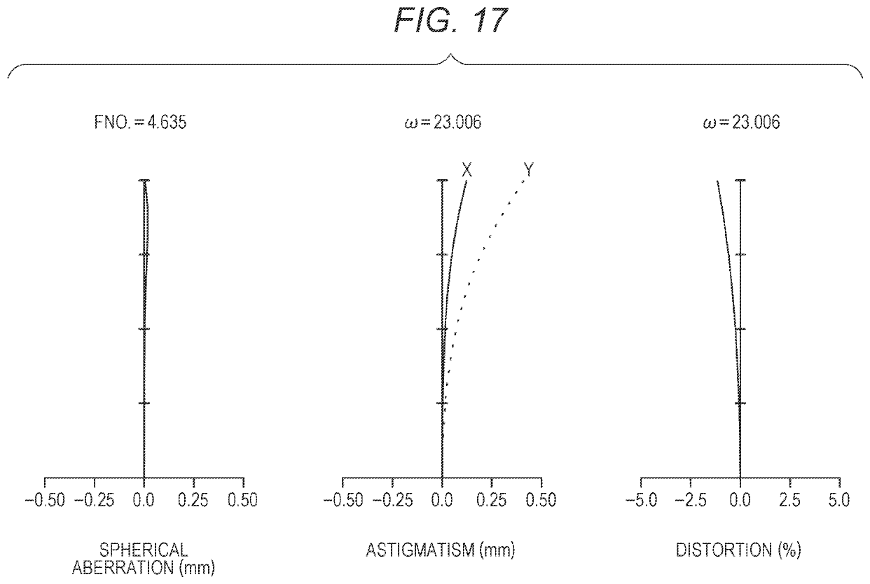

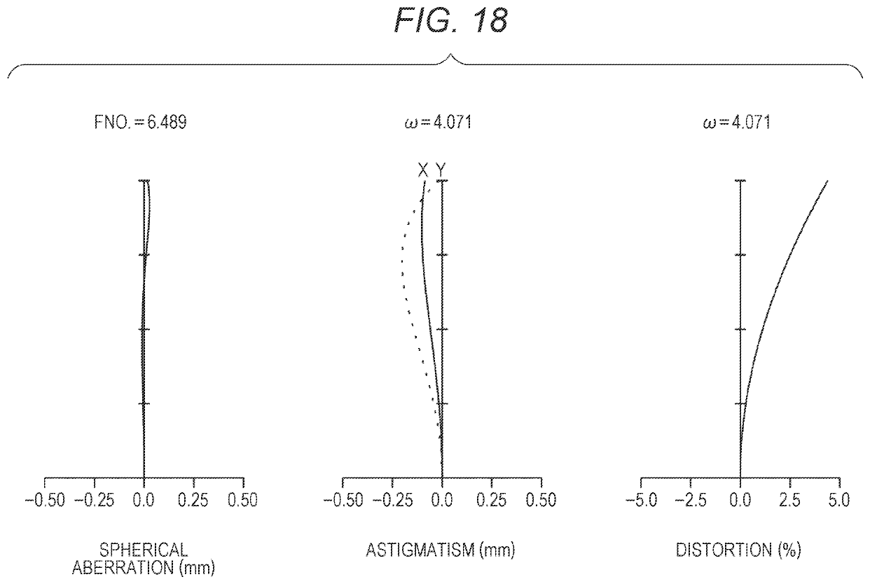

Next, numerical examples to which specific numerical values of the zoom lens are applied will be described. Values corresponding to the respective conditional expressions are shown in Table 1 below. FIGS. 17 and 18 illustrate longitudinal aberration diagrams of the zoom lens at the wide-angle end and the telephoto end during infinity focus.

(Surface Data)

| Surface No. | R | D | nd | νd |
|---|---|---|---|---|
| 1 | 177.883 | 1.2000 | 1.785896 | 44.20 |
| 2 | 66.514 | 5.4082 | 1.496997 | 81.61 |
| 3 | 764.749 | 0.1000 | | |
| 4 | 83.511 | 5.3426 | 1.496997 | 81.61 |
| 5 | −475.910 | D (5) | | |
| 6 | 108.415 | 0.9000 | 1.696797 | 55.53 |
| 7 | 29.713 | 9.0290 | | |
| 8 | −53.837 | 0.9000 | 1.592824 | 68.62 |
| 9 | −488.515 | 0.1000 | | |
| 10 | 55.080 | 2.3380 | 1.728250 | 28.32 |
| 11 | 531.894 | 2.2360 | | |
| 12 | −58.599 | 0.8000 | 1.712995 | 53.87 |
| 13 | 69.033 | 1.7848 | 1.854510 | 25.16 |
| 14 | 532.263 | D (14) | | |
| 15 | 78.377 | 3.6858 | 1.583129 | 59.46 |
| 16 | −71.204 | 1.5000 | | |
| 17STOP | inf | 1.5000 | | |
| 18 | 38.517 | 4.1180 | 1.437001 | 95.10 |
| 19 | −38.480 | 0.8000 | 2.000690 | 25.46 |
| 20 | −283.173 | 14.6407 | | |
| 21 | 165.135 | 3.0000 | 1.784719 | 25.72 |
| 22 | −34.720 | 0.8000 | 1.766340 | 35.82 |
| 23 | 39.309 | 1.0002 | | |
| 24 | 43.136 | 3.8667 | 1.766340 | 35.82 |
| 25 | −45.285 | 0.1000 | | |
| 26 | 30.135 | 4.7047 | 1.603420 | 38.01 |
| 27 | −41.268 | 0.8000 | 1.922860 | 20.88 |
| 28 | 73.962 | D (28) | | |
| 29 | 92.621 | 2.9985 | 1.922860 | 20.88 |
| 30 | −46.798 | 0.8000 | 1.834807 | 42.72 |
| 31 | 22.867 | D (31) | | |
| 32 | 38.252 | 7.0622 | 1.517417 | 52.43 |
| 33 | −27.976 | 0.1837 | | |
| 34 | −42.603 | 0.9000 | 1.910822 | 35.25 |
| 35 | 173.882 | 7.3212 | | |
| 36 | −20.981 | 1.0000 | 1.900430 | 37.37 |
| 37 | −39.317 | D (37) | | |
| 38 | inf | 2.5000 | 1.516798 | 64.20 |
| 39 | inf | 1.0000 | | |

(Specifications)

| | Wide-angle | Inter- | Telephoto |
|---|---|---|---|
| | end | mediate | end |
| f | 51.5092 | 149.9542 | 291.1392 |
| ENO | 4.6350 | 5.8796 | 6.4890 |
| ω | 23.0061 | 7.8255 | 4.0708 |
| Image | 21.6330 | 21.6330 | 21.6330 |
| height | | | |

(Variable interval)

| | Wide-angle | Inter- | Telephoto |
|---|---|---|---|
| | end | mediate | end |
| D (5) | 1.0000 | 52.7896 | 81.7906 |
| D (14) | 39.3119 | 10.4390 | 1.1070 |
| D (28) | 1.6601 | 5.3224 | 1.4142 |
| D (31) | 14.4285 | 10.1608 | 12.9932 |
| D (37) | 19.1790 | 32.0304 | 40.8407 |

### Example 7

### (1) Optical Configuration

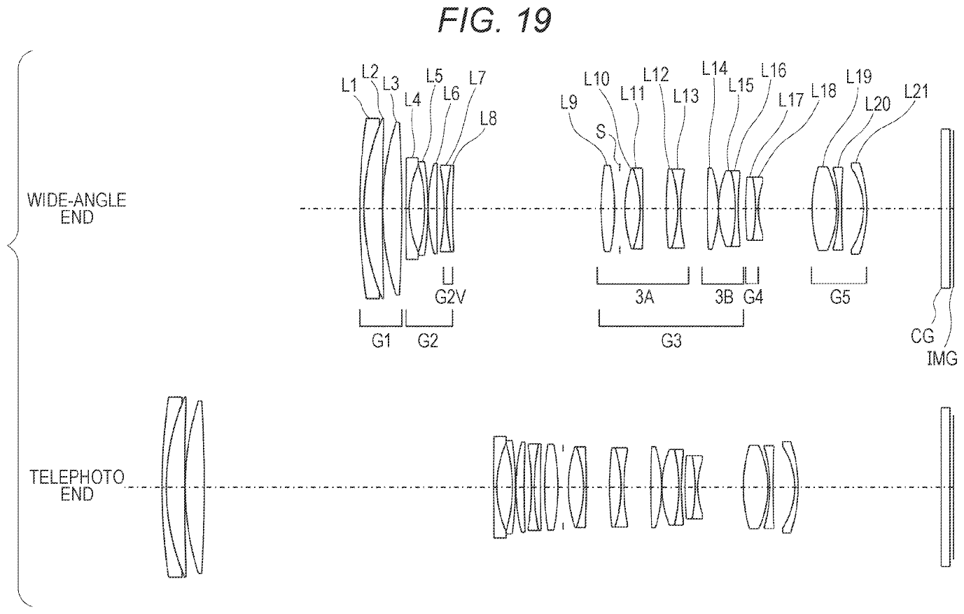

FIG. 19 is a cross-sectional view of the zoom lens according to Example 7 of the present invention at a wide-angle end during infinity focus. The zoom lens includes, in order from the object side, a first lens group G1 having positive refractive power, a second lens group G2 having negative refractive power, a third lens group G3 having positive refractive power, a fourth lens group G4 having negative refractive power, and a fifth lens group G5 having negative refractive power. The second lens group G2 includes a vibration-compensation group G2V, and the third lens group includes an object side portion group 3A and an image side portion group 3B. An air interval between the object side portion group 3A and the image side portion group 3B is the largest in the third lens group G3. An aperture diaphragm S is disposed in the object side portion group 3A. Hereinafter, the configuration of each lens group will be described.

The first lens group G1 includes a cemented lens in which a negative meniscus lens L1 convex toward the object side and a positive meniscus lens L2 convex toward the object side are cemented in order from the object side, and a biconvex lens L3.

The second lens group G2 includes, in order from the object side, a negative meniscus lens L4 convex toward the object side, a negative meniscus lens L5 concave toward the object side, a positive meniscus lens L6 convex toward the object side, and a cemented lens in which a biconcave lens L7 and a positive meniscus lens L8 convex toward the object side are cemented. This cemented lens constitutes the vibration-compensation group G2V.

As described above, the third lens group G3 includes the object side portion group 3A and the image side portion group 3B. The object side portion group 3A includes a biconvex lens L9, a cemented lens obtained by cementing the biconvex lens L10 and the negative meniscus lens L11 concave to the object side, and a cemented lens obtained by cementing the biconvex lens L12 and the biconcave lens L13. An aperture diaphragm S is disposed between the biconvex lens L9 and the biconvex lens L10. The biconvex lens L10 satisfies the above Expression (4).

The image side portion group 3B includes, in order from the object side, a biconvex lens L14, and a cemented lens in which a biconvex lens L15 and a biconcave lens L16 are cemented. The biconvex lens L14 and the biconvex lens L15 satisfy both Expressions (1) and (2).

The fourth lens group G4 includes a cemented lens in which a biconvex lens L17 and a biconcave lens L18 are cemented in order from the object side.

The fifth lens group G5 includes, in order from the object side, a biconvex lens L19, a biconcave lens L20, and a negative meniscus lens L21 concave to the object side.

When the magnification is changed from the wide-angle end to the telephoto end, the first lens group G1 moves to the object side, the second lens group G2 moves to the image side, and the third lens group G3, the fourth lens group G4, and the fifth lens group G5 move to the object side by different movement amounts. In focusing from infinity to a near-distance object, the fourth lens group G4 moves to the image side. When correcting image blurring based on camera shake or the like at the time of imaging, the vibration-compensation group G2V is moved in a direction perpendicular to the optical axis.

### (2) Numerical Examples

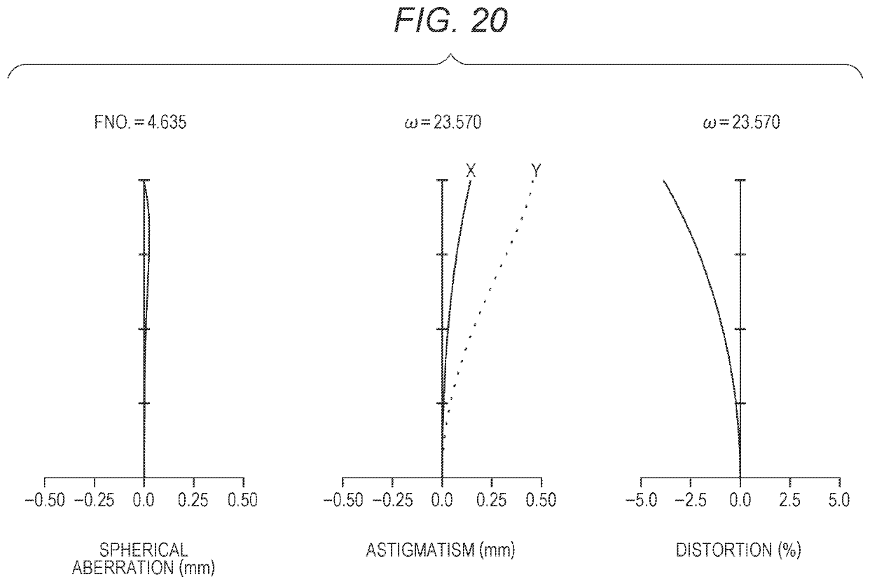

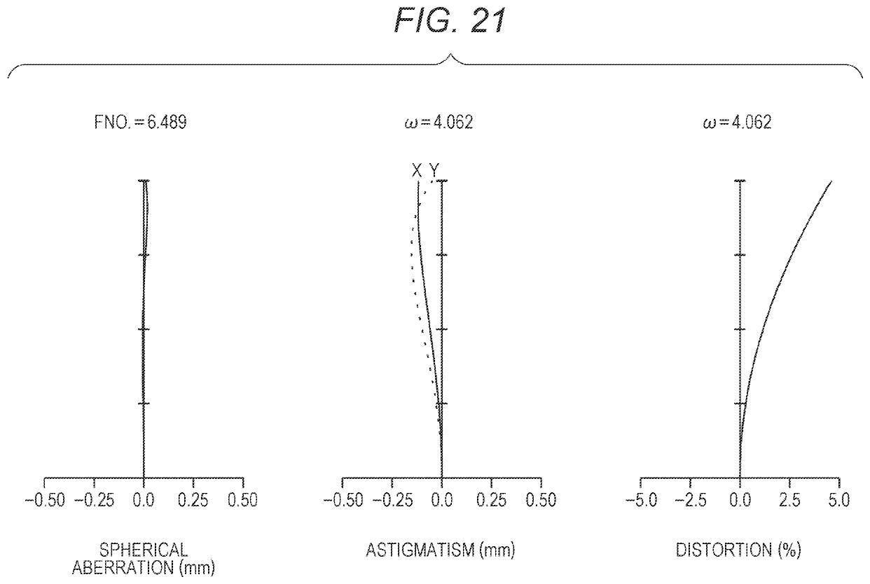

Next, numerical examples to which specific numerical values of the zoom lens are applied will be described. Values corresponding to the respective conditional expressions are shown in Table 1 below. FIGS. 20 and 21 illustrate longitudinal aberration diagrams of the zoom lens at the wide-angle end and the telephoto end during infinity focus.

(Surface Data)

| Surface No. | R | D | nd | νd |
|---|---|---|---|---|
| 1 | 179.996 | 1.2000 | 1.785896 | 44.20 |
| 2 | 66.002 | 5.2989 | 1.496997 | 81.61 |
| 3 | 909.309 | 0.1000 | | |
| 4 | 82.359 | 5.4516 | 1.496997 | 81.61 |
| 5 | −429.369 | D (5) | | |
| 6 | 2229.026 | 0.9000 | 1.696797 | 55.53 |
| 7 | 31.862 | 4.4302 | | |
| 8 | −45.638 | 0.9000 | 1.592824 | 68.62 |
| 9 | −99.318 | 0.1000 | | |
| 10 | 51.294 | 2.4350 | 1.728250 | 28.32 |
| 11 | 450.759 | 2.0677 | | |
| 12 | −71.126 | 0.8000 | 1.712995 | 53.87 |
| 13 | 65.508 | 1.7416 | 1.854510 | 25.16 |
| 14 | 291.793 | D (14) | | |
| 15 | 77.724 | 3.8605 | 1.583129 | 59.46 |
| 16 | −61.266 | 1.5000 | | |
| 17STOP | inf | 1.5000 | | |
| 18 | 37.363 | 4.2959 | 1.437001 | 95.10 |
| 19 | −34.158 | 0.8000 | 2.000600 | 25.46 |
| 20 | −404.074 | 6.6653 | | |
| 21 | 106.849 | 3.3098 | 1.784719 | 25.72 |
| 22 | −37.587 | 0.8000 | 1.766340 | 35.82 |
| 23 | 54.196 | 7.6653 | | |
| 24 | 220.372 | 3.1363 | 1.766340 | 35.82 |
| 25 | −38.417 | 0.1000 | | |
| 26 | 28.997 | 4.7882 | 1.603420 | 38.01 |
| 27 | −49.574 | 0.8000 | 1.922860 | 20.88 |
| 28 | 96.026 | D (28) | | |
| 29 | 99.690 | 2.8598 | 1.922860 | 20.88 |
| 30 | −48.286 | 0.8000 | 1.834807 | 42.72 |
| 31 | 23.087 | D (31) | | |
| 32 | 41.043 | 7.0258 | 1.517417 | 52.43 |
| 33 | −28.220 | 0.5486 | | |
| 34 | −42.593 | 0.9000 | 1.910822 | 35.25 |
| 35 | 219.282 | 6.2271 | | |
| 36 | −21.538 | 1.0000 | 1.900430 | 37.37 |
| 37 | −40.823 | D (37) | | |
| 38 | inf | 2.5000 | 1.516798 | 64.20 |
| 39 | inf | 1.0000 | | |

(Specifications)

| | Wide-angle | Inter- | Telephoto |
|---|---|---|---|
| | end | mediate | end |
| f | 51.4983 | 149.8956 | 290.9802 |
| ENO | 4.6350 | 5.4115 | 6.4890 |
| ω | 23.5704 | 7.8262 | 4.0622 |
| Image | 21.6330 | 21.6330 | 21.6330 |
| height | | | |

(Variable interval)

| | Wide-angle | Inter- | Telephoto |
|---|---|---|---|
| | end | mediate | end |
| D (5) | 1.2205 | 54.8108 | 82.8875 |
| D (14) | 42.4668 | 9.5701 | 1.1745 |
| D (28) | 2.1444 | 6.1922 | 1.0225 |
| D (31) | 15.3673 | 9.2599 | 13.0112 |
| D (37) | 21.2932 | 31.4645 | 40.9640 |

TABLE 1

| | Example | Example | Example | Example | Example |
|---|---|---|---|---|---|
| | 1 | 2 | 3 | 4 | 5 |
| Expression (1) (ng − nF)/(nF − nC) | 0.583 | 0.583 | 0.583 | 0.583 | 0.579 |
| Expression (2) νd3B | 34.707 | 34.707 | 34.707 | 34.707 | 35.823 |
| Expression (1) (ng − nF)/(nF − nC) | | | 0.583 | 0.574 | 0.583 |
| Expression (2) νd3B | | | 38.010 | 39.682 | 39.682 |
| Expression (5) f2V/f2 | 1.975 | 1.942 | 2.100 | 2.051 | 1.996 |
| Expression (6) f1/fw | 2.647 | 2.650 | 2.658 | 2.657 | 2.661 |
| Expression (7) β2t | −1.082 | −1.065 | −1.090 | −1.104 | −1.118 |
| Expression (8) (1 − β4t²) × β5t² | −8.080 | −7.652 | −7.666 | −8.241 | −8.603 |
| Expression (9) β2t/β2w | 3.575 | 3.500 | 3.666 | 3.711 | 3.795 |
| Expression (3) 3DM/OALw | 0.071 | 0.072 | 0.077 | 0.074 | 0.065 |
| Expression (4) νd3A | 81.607 | 81.607 | 81.607 | 81.607 | 81.607 |

| | Example | Example |
|---|---|---|
| | 6 | 7 |
| Expression (1) (ng − nF)/(nF − nC) | 0.579 | 0.579 |
| Expression (2) νd3B | 35.823 | 35.823 |
| Expression (1) (ng − nF)/(nF − nC) | 0.583 | 0.583 |
| Expression (2) νd3B | 38.010 | 38.010 |
| Expression (5) f2V/f2 | 2.443 | 2.567 |
| Expression (6) f1/fw | 3.037 | 2.939 |
| Expression (7) β2t | −1.124 | −1.367 |
| Expression (8) (1 − β4t²) × β5t² | −10.010 | −10.010 |
| Expression (9) β2 β2t/β2w | 3.603 | 4.100 |
| Expression (3) 3DM/OALw | 0.086 | 0.045 |
| Expression (4) νd3A | 95.099 | 95.099 |

### SUMMARY

A zoom lens according to a first aspect of the present invention is a zoom lens including: in order from an object side, a first lens group having positive refractive power; a second lens group having negative refractive power; a third lens group having positive refractive power; a fourth lens group having negative refractive power; and a fifth lens group having negative refractive power. Magnification varies by changing an interval on an optical axis between adjacent lens groups. The third lens group includes an object side portion group arranged on an object side with a widest air interval in the third lens group, and an image side portion group arranged on an image side with the air interval. The second lens group moves along an optical axis when magnification changes. The object side portion group and the image side portion group each include a positive lens, a positive lens, and a negative lens arranged in order from an object side.

In a zoom lens according to a second aspect of the present invention, in the first aspect, it is preferable that at least one of the positive lenses included in the image side portion group satisfies the following Expressions (1) and (2).

$$0.565 < ( ng - nF ) / ( nF - nC ) < 0.6 \qquad ( 1 )$$

$$33. < vd 3 B < 41. \qquad ( 2 )$$

Where,

ng is a refractive index with respect to g-line of positive lens included in image side portion group;

nF is a refractive index with respect to F-line of positive lens included in image side portion group;

nC is a refractive index with respect to C-line of positive lens included in image side portion group; and

νd3B is Abbe number of positive lens included in the image side portion group with respect to d-line.

In a zoom lens according to a third aspect of the present invention, in the first aspect or the second aspect,
it is preferable that the second lens group includes a vibration-compensation group that corrects image blurring by moving in a direction perpendicular to the optical axis, and satisfies the following Expression (5).

$$1.75 < f 2 V / f 2 < 2.82 \qquad ( 5 )$$

Where,

f2V is a focal length of the vibration-compensation group; and

f2 is a focal length of the second lens group.

In any one of the first to third aspects, the zoom lens according to a fourth aspect of the present invention preferably satisfies the following expression.

$$2.38 < f 1 / fw < 3.34 \qquad ( 6 )$$

Where,

f1 is a focal length of the first lens group; and

fw is a focal length of the zoom lens at the wide-angle end.

In the zoom lens according to a fifth aspect of the present invention, in any one of the first to fourth aspects, it is preferable that the fourth lens group is moved in the optical axis direction to focus on a near-distance object from infinity.

In any one of the first to fifth aspects, the zoom lens according to the sixth aspect of the present invention preferably satisfies the following expression.

$$- 1.5 < β2 t < - 0.96 \qquad ( 7 )$$

Where,

β2t is a lateral magnification of the second lens group at the telephoto end.

In any one of the first to sixth aspects, the zoom lens according to a seventh aspect of the present invention preferably satisfies the following expression.

$$- 11.01 < ( 1 - β4 {t}^{2} ) \times β5 {t}^{2} < - 6.89 \qquad ( 8 )$$

Where,

β4t is a lateral magnification of the fourth lens group at the telephoto end; and

β5t is a lateral magnification of the fifth lens group at the telephoto end.

In any one of the first to seventh aspects, the zoom lens according to an eighth aspect of the present invention preferably satisfies the following expression.

$$3.15 < β2 t / β2 w < 4.51 \qquad ( 9 )$$

Where,

β2t is a lateral magnification of the second lens group at the telephoto end; and

β2w is a lateral magnification of the second lens group at the wide-angle end.

An imaging device according to a ninth aspect of the present invention may include the zoom lens according to the first aspect to the eighth aspect, and an image sensor that is provided on an image side of the zoom lens and converts an optical image formed by the zoom lens into an electrical signal.

According to the present invention, it is possible to provide a zoom lens and an imaging device which have high optical performance, are compact, and have a high magnification ratio.

What is claimed is:

1. A zoom lens comprising:
in order from an object side,
a first lens group having positive refractive power;
a second lens group having negative refractive power;
a third lens group having positive refractive power;
a fourth lens group having negative refractive power; and
a fifth lens group having negative refractive power, wherein
magnification varies by changing an interval on an optical axis between adjacent lens groups,
the third lens group includes an object side portion group arranged on an object side with a widest air interval in the third lens group, and an image side portion group arranged on an image side with the air interval,
the second lens group moves along an optical axis at a time of magnification change, and
the object side portion group and the image side portion group each include a positive lens, a positive lens, and a negative lens arranged in order from an object side.

2. The zoom lens according to claim 1, wherein at least one of the positive lenses included in the image side portion group satisfies following Expressions (1) and (2):
$$0.565 < ( ng - nF ) / ( nF - nC ) < 0.6 \qquad ( 1 )$$
$$33. < vd 3 B < 41. \qquad ( 2 )$$
where,
ng is a refractive index of a positive lens included in the image side portion group with respect to a g-line;
nF is a refractive index of a positive lens included in the image side portion group with respect to an F-line;
nC is a refractive index of a positive lens included in the image side portion group with respect to a C-line; and
νd3B is Abbe number of positive lens included in the image side portion group with respect to d-line

3. The zoom lens according to claim 1, wherein the second lens group includes a vibration-compensation group that moves in a direction perpendicular to the optical axis to correct image blurring, and satisfies following Expression (5):
$$1.75 < f 2 V / f 2 < 2.82 \qquad ( 5 )$$
where,
f2V is a focal length of the vibration-compensation group; and
f2 is a focal length of the second lens group.

4. The zoom lens according to claim 1, wherein a following expression is satisfied:
$$2.38 < f 1 / fw < 3.34 \qquad ( 6 )$$
where,
f1 is a focal length of the first lens group; and
fw is a focal length of the zoom lens at a wide-angle end.

5. The zoom lens according to claim 1, wherein the fourth lens group is moved in an optical axis direction to focus on a near-distance object from infinity.

6. The zoom lens according to claim 1, wherein a following expression is satisfied:
$$- 1.5 < β2 t < - 0.96 \qquad ( 7 )$$
where,
β2t is a lateral magnification of the second lens group at a telephoto end.

7. The zoom lens according to claim 5, wherein a following expression is satisfied:
$$- 11.01 < ( 1 - β4 {t}^{2} ) \times β5 {t}^{2} < - 6.89 \qquad ( 8 )$$
where,
β4t is a lateral magnification of the fourth lens group at a telephoto end; and
β5t is a lateral magnification of the fifth lens group at a telephoto end.

8. The zoom lens according to claim 1, wherein a following expression is satisfied:
$$3.15 < β2 t / β2 w < 4.51 \qquad ( 9 )$$
where,
β2t is a lateral magnification of the second lens group at a telephoto end; and
β2w is a lateral magnification of the second lens group at a wide-angle end.

9. An imaging device comprising:
the zoom lens according to claim 1; and
an image sensor that is provided on an image side of the zoom lens and converts an optical image formed by the zoom lens into an electrical signal.
